(19) United States
(12) Patent Application Publication
(10) Pub. No.: US 2026/0005889 A1
(43) Pub. Date: Jan. 1, 2026

(54) ADVANCED SYSTEMS AND METHODS FOR SELF-LEARNING RECOMMENDER SYSTEM FOR GROUP PERFORMANCE AND GROUP CREATIVITY

(71) Applicant: Sunshine in Interaction, Wien (AT)

(72) Inventors: Thomas Spielhofer, Wien (AT); Lorenz Glatz, Wien (AT)

(21) Appl. No.: 19/289,768

(22) Filed: Aug. 4, 2025

Related U.S. Application Data
(63) Continuation-in-part of application No. 19/205,445, filed on May 12, 2025.
(60) Provisional application No. 63/645,293, filed on May 10, 2024.
(60) Provisional application No. 63/679,287, filed on Aug. 5, 2024.
(60) Provisional application No. 63/687,868, filed on Aug. 28, 2024.

(51) Int. Cl. H04L 12/18; G06F 16/68; G06F 16/683

(52) U.S. Cl. CPC H04L 12/1831; G06F 16/683; G06F 16/686

(57) ABSTRACT

A system for dynamically generating and analyzing metadata for online meetings is provided. The system is programmed to: a) receive at least one stream of at least one of audio and video of an online meeting, wherein the at least one stream includes a plurality of participants participating in the online meeting; b) extract a plurality of metadata from the at least one stream; c) perform diarization on the at least one stream and the plurality of metadata the at least one stream to generate diarization information; d) analyze the diarization information to calculate one or more key performance indicators (KPIs); e) determine a recommendation to change the one or more KPIs; and/or f) generate visualization of at least one of the key performance indicators and the recommendation to be displayed to one or more participants in the online meeting.

### CROSS REFERENCE TO RELATED APPLICATIONS

This application is a continuation in part of U.S. patent application Ser. No. 19/205,445, filed May 12, 2025, which claims priority to U.S. Provisional Patent Application No. 63/645,293, filed May 10, 2024. This application also claims priority to U.S. Provisional Patent Application No. 63/679,287, filed Aug. 5, 2024, and to U.S. Provisional Patent Application No. 63/687,868, filed Aug. 5, 2024, which are hereby incorporated by reference in their entireties.

### BACKGROUND

The field of the invention relates generally to generating and analyzing metadata for online meetings.

As their quality has improved over time, online meetings have become increasingly prevalent in various domains, facilitating communication and collaboration among geographically dispersed participants. At the same time online meetings reduce our ability to experience and participate in non-verbal communication, a key component of any human interaction. Existing methods for analyzing the data generated during these meetings are not yet able to substitute for this deficiency, even more so when it comes to providing insights into group dynamics, group and participant behavior, and meeting efficiency.

This background section is intended to introduce the reader to various aspects of art that may be related to various aspects of the present disclosure, which are described and/or claimed below. This discussion is believed to be helpful in providing the reader with background information to facilitate a better understanding of the various aspects of the present disclosure. Accordingly, it should be understood that these statements are to be read in this light, and not as admissions of prior art.

### BRIEF DESCRIPTION

In one aspect, a system for dynamically generating and analyzing metadata for online meetings is provided. The system includes a computer device includes at least one processor in communication with at least one memory device. The at least one memory device stores computer-implemented instructions that cause the at least one processor to: a) receive at least one stream of at least one of audio and video of an online meeting, wherein the at least one stream includes a plurality of participants participating in the online meeting; b) extract a plurality of metadata from the at least one stream; c) perform diarization on the at least one stream and the plurality of metadata the at least one stream to generate diarization information, wherein the diarization information includes information about participation for the plurality of participants in the online meeting; d) analyze the diarization information to calculate one or more key performance indicators (KPIs); e) determine a recommendation to change the one or more KPIs; and/or f) generate visualization of at least one of the key performance indicators and the recommendation to be displayed to one or more participants in the online meeting. The system may have additional, less, or alternate functionalities, including those discussed elsewhere herein.

In another aspect, a computer device for dynamically generating and analyzing metadata for online meetings is provided. The computer device includes at least one processor in communication with at least one memory device. The at least one memory device stores computer-implemented instructions that cause the at least one processor to: a) receive at least one stream of at least one of audio and video of an online meeting, wherein the at least one stream includes a plurality of participants participating in the online meeting; b) extract a plurality of metadata from the at least one stream; c) perform diarization on the at least one stream and the plurality of metadata the at least one stream to generate diarization information, wherein the diarization information includes information about participation for the plurality of participants in the online meeting; d) analyze the diarization information to calculate one or more key performance indicators (KPIs); e) determine a recommendation to change the one or more KPIs; and/or f) generate visualization of at least one of the key performance indicators and the recommendation to be displayed to one or more participants in the online meeting. The computer device may have additional, less, or alternate functionalities, including those discussed elsewhere herein.

In further aspect, a computer-implemented method for dynamically generating and analyzing metadata for online meetings is provided. The method is implemented on a computer device including at least one processor in communication with at least one memory device. The computer-implemented method includes: a) receiving at least one stream of at least one of audio and video of an online meeting, wherein the at least one stream includes a plurality of participants participating in the online meeting; b) extracting a plurality of metadata from the at least one stream; c) performing diarization on the at least one stream and the plurality of metadata the at least one stream to generate diarization information, wherein the diarization information includes information about participation for the plurality of participants in the online meeting; d) analyzing the diarization information to calculate one or more key performance indicators (KPIs); e) determining a recommendation to change the one or more KPIs; and/or f) generating visualization of at least one of the key performance indicators and the recommendation to be displayed to one or more participants in the online meeting. The system may have additional, less, or alternate functionalities, including those discussed elsewhere herein.

In one aspect, a system for dynamically generating and analyzing metadata for online meetings is provided. The system includes a computer device comprising at least one processor in communication with at least one memory device. The at least one memory device stores computer-implemented instructions that cause the at least one processor to: a) receive at least one stream of at least one of audio and video of an online meeting, wherein the at least one stream includes a plurality of participants participating in the online meeting; b) extract a plurality of metadata from the at least one stream; c) perform diarization on the at least one stream and the plurality of metadata the at least one stream to generate diarization information, wherein the diarization information includes information about participation for the plurality of participants in the online meeting; d) analyze the diarization information to calculate one or more key performance indicators (KPIs); e) determine a recommendation to change the one or more KPIs; and/or f) generate visualization of at least one of the key performance indicators and the recommendation to be displayed to one or more participants in the online meeting. The system may have additional, less, or alternate functionalities, including those discussed elsewhere herein.

Various refinements exist of the features noted in relation to the above-mentioned aspects. Further features may also be incorporated in the above-mentioned aspects as well. These refinements and additional features may exist individually or in any combination. For instance, various features discussed below in relation to any of the illustrated embodiments may be incorporated into any of the above-described aspects, alone or in any combination.

### BRIEF DESCRIPTION OF THE DRAWINGS

The Figures described below depict various aspects of the systems and methods disclosed. It should be understood that each Figure depicts an embodiment of a particular aspect of the disclosed systems and methods, and that each of the Figures is intended to accord with a possible embodiment thereof. Further, wherever possible, the following description refers to the reference numerals included in the following Figures, in which features depicted in multiple Figures are designated with consistent reference numerals. There are shown in the drawings arrangements presently discussed, it being understood, however, that the present embodiments are not limited to the precise arrangements.

FIG. 1 illustrates a timing diagram for a process for dynamically generating and analyzing metadata for online meetings in real-time, in accordance with at least one embodiment.

FIG. 2 illustrates a timing diagram for a process for dynamically analyzing online meeting metadata within the context of a Microsoft Teams call in real-time, in accordance with at least one embodiment.

FIG. 3A illustrates a flow diagram of a process for diarization in the context of online meeting analysis in real-time, in accordance with at least one embodiment of this disclosure.

FIG. 3B illustrates a graph of diarization as provided by process shown in FIG. 3.

FIG. 4 illustrates the flow of an online meeting being analyzed by the processes shown in FIGS. 1-3A.

FIG. 5 illustrates an exemplary computer system for performing the processes shown in FIGS. 1-3A.

FIG. 6 illustrates an exemplary configuration of a client computer device shown in FIG. 5, in accordance with one embodiment of the present disclosure.

FIG. 7 depicts an exemplary configuration of a server computer device, in accordance with one embodiment of the present disclosure.

FIG. 8 illustrates an example process for calculating Key Performance Indicators (KPIs) based on received diarization.

FIG. 9 illustrates a process for enhancing team creativity during online meetings by providing real-time feedback and recommendations to the meeting moderator or leader.

FIG. 10 illustrates a more simplified process for enhancing team creativity during online meetings, focusing on real-time feedback without the use of AI or reinforcement learning.

FIG. 11 illustrates deep reinforcement learning process for this disclosure.

FIG. 12 illustrates an example process for dynamic diarization-based group performance analysis in online meetings.

FIG. 13 outlines a systematic process of evaluating team productivity in online meetings and providing tailored recommendations to improve group performance using AI agent-optimized feedback.

FIG. 14 outlines a systematic process of evaluating team productivity in online meetings and providing tailored recommendations to improve group performance.

FIG. 15 illustrates deep reinforcement learning process for this disclosure.

FIG. 16 illustrates an example dashboard for use with processes shown in FIGS. 8-11.

FIG. 17 illustrates an example dashboard for use with process processes shown in FIGS. 12-15.

FIG. 18 illustrates an example dashboard for use with process processes shown in FIGS. 12-15.

Unless otherwise indicated, the drawings provided herein are meant to illustrate features of embodiments of this disclosure. These features are believed to be applicable in a wide variety of systems including one or more embodiments of this disclosure. As such, the drawings are not meant to include all conventional features known by those of ordinary skill in the art to be required for the practice of the embodiments disclosed herein.

### DETAILED DESCRIPTION

The present disclosure introduces a system and method for analyzing online meeting metadata to extract valuable insights regarding group dynamics, group intelligence, participant behavior, meeting effectiveness, productivity, and creativity. The system calculates metrics based on the online meeting metadata metrics. These metrics have been shown to be key meeting success indicators in scientific research in a variety of meeting contexts. By leveraging advanced data processing techniques and machine learning algorithms, the system provides detailed analyses of various aspects of online meetings, including participant speaking patterns, audio characteristics, and group performance metrics. The system thus substitutes the deficiency of online meetings in nonverbal communications with providing context and information by extracting information from the metadata of the meeting that is not available to the participants otherwise.

The system described herein comprises components for capturing, processing, and analyzing meeting metadata, as well as modules for generating reports, visualizations, and recommendations to aid in data interpretation. Key components include, but are not limited to, a Meeting Metadata Capture Module, a Data Processing and Analysis Module, a Reporting and Visualization Module, and a Recommendations Module.

The Meeting Metadata Capture Module is responsible for collecting data generated during online meetings, including participant speaking patterns, audio characteristics (such as volume, pitch, and rate of speaking), and metadata related to participant location and date/time of participation. However, for privacy reasons, the content of the meeting itself is not captured.

The Data Processing and Analysis Module utilizes machine learning algorithms and statistical techniques. The module processes the captured metadata to extract relevant insights regarding participant behavior, group dynamics, group intelligence, meeting effectiveness, productivity, and creativity. The module employs techniques such as diarization to segment the audio data and identify individual speakers. The module also uses other algorithms to analyze speaking patterns and audio characteristics to assess participant engagement and communication effectiveness. The online meeting metadata metrics being calculated have been shown to be key meeting success indicators in scientific research in a variety of meeting contexts.

The Reporting and Visualization Module generates comprehensive reports and visualizations in real time, or after the meeting, summarizing the findings from the data analysis. These reports provide insights into various aspects of the online meetings, including participant speaking time, contribution levels, group intelligence, and other meeting related scores. Visualizations such as graphs and charts are used to present the data in an easily interpretable format.

The Recommendations Module uses metadata of the group interaction to make recommendations to the meeting participants or other third-parties to increase the overall success of the meeting based on scientific findings. This can happen in real time during the meeting and/or after the meeting as a summary report.

As used herein, an Online Meeting is considered a synchronous communication between two or more participants via an audio or video conferencing tool.

As used herein, Meeting Metadata is data that describes data resulting from an audio or video meeting, including participant speaking patterns, audio characteristics, participant location, and date/time of participation. However, metadata does not include the content of the meeting itself.

As used herein, Diarization is a dataset of all occurrences at which a participant spoke during an audio meeting, including length (but not audio volume, pitch, and rate of speaking.)

As used herein, Group Intelligence is the performance or productivity of a team according to a test measuring team performance introduced in scientific research.

As used herein, an Audio or Video Provider is a company or service provider offering software platforms or applications enabling audio or video meetings.

As used herein, a Host UI includes user interface software provided by the party hosting the audio or video meetings.

As used herein, a Provider Specific Backend includes Backend infrastructure specific to a particular audio or video provider.

As used herein, a Host General Purpose Backend includes the Meeting host's software independent of service provider specifics.

As used herein, a Host Datastore is one or more databases where all metadata is stored.

As used herein, a processor ML (Machine Learning) is a computer program able to learn from experience with respect to some class of tasks.

The described system and method offer several advantages over traditional diarization approaches, including: i) Improved accuracy in speaker segmentation by dynamically adjusting segments based on speech activity; ii) Real-time analysis capabilities enable timely insights into participant behavior and meeting dynamics; and iii) Enhanced efficiency through automated segmentation of audio data, reducing the need for manual intervention.

Below are a series of key performance indicator (KPIs) used herein.

AvgDis: the average distance of all participant's turn taking from the average turn taking.

DAP: diarization of all participants.

GII: The intensity of group interaction, calculated by dividing overall turn taking by the elapsed time.

GP: The Conversational Gravity. This is the ratio: centrality of each user/total of all centralities, thus indicating the centrality of a meeting participant relative to the centrality of the other participants.

RST: The relative speaking time for a participant, calculated by building the ratio of his/her relative speaking time and the total speaking time of all participants.

TT: Turn taking, i.e., the number of times each participant spoke in a given time span.

TTT: The total number of turn takings of all participants within a given time span.

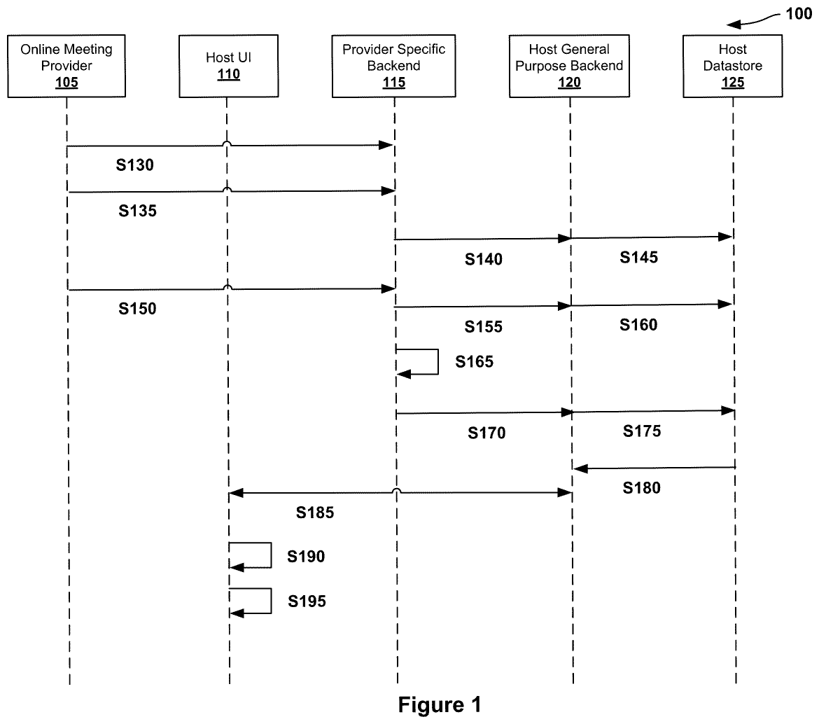

FIG. 1 illustrates a timing diagram for a process 100 for dynamically generating and analyzing metadata for online meetings in real-time, in accordance with at least one embodiment. In the example embodiment, an online meeting provider 105 is in communication with a host system. The host system facilitates the analysis of online meeting metadata by integrating various components to capture, process, and visualize data. The host system may include, but is not limited to, a host UI 110, a provider specific backend 115, a host general purpose backend 120 and at least one host datastore 125. In some embodiments, the host system is associated with one or more of the users attending the online meeting. In other embodiments, the host system is associated with a company or enterprise that is providing the online meeting or has hired the online meeting provider 105.

The online meeting provider 105 is a company or service provider offering software platforms or applications enabling audio and/or video meetings. In many embodiments, the online meeting provider 105 is in communication with a plurality of user device, where the user devices are providing communication with other user devices via the online meeting provider 105. The user devices may include an application that allows them to connect to the online meeting provider 105.

The Host UI 110 includes user interface software provided by the party hosting the audio and/or video meetings. The Provider Specific Backend 115 includes Backend infrastructure specific to a particular audio and/or video provider. The Host General Purpose Backend 120 includes the Meeting host's software independent of service provider specifics. The Host Datastore 125 is one or more databases where all metadata is stored.

In Step S130, the user initiates a call. The process 100 begins when a user initiates S130 an online meeting call through the online meeting provider's platform 105. Upon initiation of the call, the provider-specific backend component 115 extracts S135 the local date and time information of each participant involved in the meeting. In some embodiments, this information is provided by the online meeting provider 105. In Step S135, the Provider-Specific Backend Extracts 115 the Locations of Participants. Simultaneously to step S130, the provider-specific backend 115 extracts S135 the location data of participants, including geographical coordinates or other location identifiers. In Step S140, the Provider-Specific Backend 115 Sends Extracted Metadata to the General Purpose Backend 120. The extracted metadata, including local date and time and participant locations, is sent S140 to the general purpose backend 120 for further processing and then for storage S145 in the datastore 125.

In Step S150, the Online Meeting Provider 105 Continuously Sends Audio Stream data captured during the meeting to the provider specific backend 115 throughout the duration of the meeting. In Step S155, the Provider-Specific Backend 115 Sends Extracted Audio Metadata to the General Purpose Backend 120. The provider-specific backend 115 continuously extracts audio metadata such as pitch, volume, and rate of speaking from the audio stream. This extracted audio metadata is then sent S155 to the general purpose backend 120 for further analysis and to the datastore 125 for storage S160. In Step S165, the Provider-Specific Backend 115 Continuously Calculates Diarization. Diarization is the process of segmenting audio data to identify individual speakers is continuously calculated by the provider-specific backend component 115. In Step S170, the Provider-Specific Backend 115 Sends Calculated Diarization to the General Purpose Backend 120. The calculated diarization information identifies individual speakers and their respective speech segments. In Steps S170 and S175, the calculated diarization is sent to the general purpose backend 120 for subsequent analysis and to the datastore 125 for storage. Steps S150 through S175 continuously repeat as the meeting continues.

In Step S185, the UI 110 Continuously Polls for Diarization from General Purpose Backend 120. The user interface (UI) component 110 continuously polls the general purpose backend 120 to retrieve the latest diarization information stored in the datastore 125. This information may be loaded S180 from the datastore 125 as needed.

In Step S190, the UI 110 Calculates Key Performance Indicators (KPIs) Based on Received Diarization. Upon receiving the diarization data, the UI 110 calculates key performance indicators (KPIs) such as participant speaking time, contribution levels, and other relevant metrics based on the identified speaker segments. Then in Step S195, the UI 110 Visualizes Calculated KPIs and Diarization. The UI component 110 visualizes the calculated KPIs and diarization information in an easily interpretable format, such as graphs, charts, or other visualization tools, providing users with valuable insights into participant behavior and meeting dynamics. The UI component 110 additionally furnishes meeting participants and third-parties with real-time guidance, aiding in enhancing the meeting's success rate.

This detailed description of process 100 illustrates the systematic flow of operations within the system for analyzing online meeting metadata, from data capture and processing to visualization and analysis.

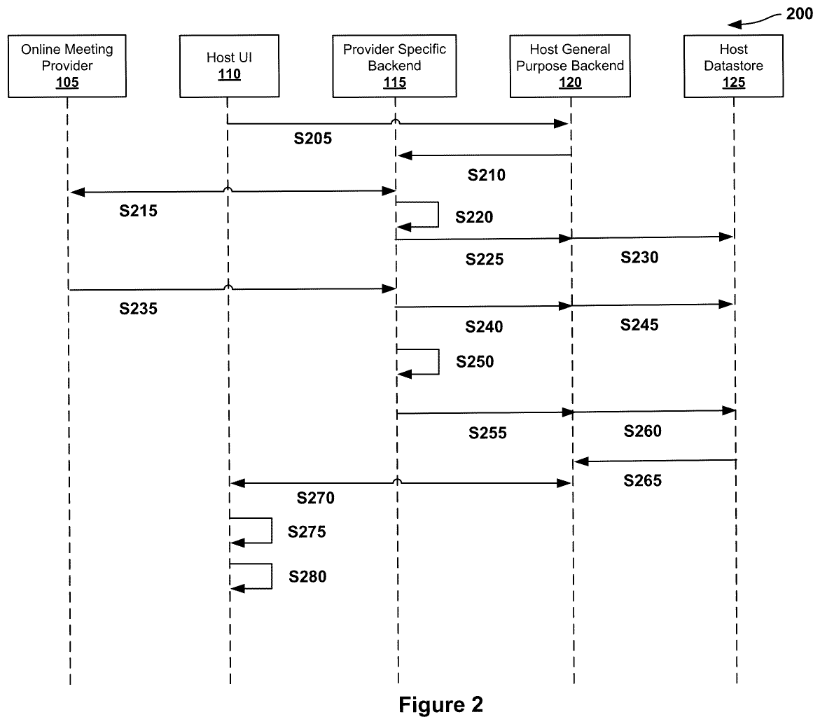

FIG. 2 illustrates a timing diagram for a process 200 for dynamically analyzing online meeting metadata within the context of a Microsoft Teams call in real-time, in accordance with at least one embodiment. One having skill in the art would have understand that process 200 could be used with other online meeting providers 105, such as, but not limited to, Zoom and Google Meetings.

In Step S205, the user requests bot to join the call. The process 200 begins when a user requests a bot to join the online meeting call, specifically within the Microsoft Teams platform. In the example embodiment, the bot is a part of the provider specific backend 115 and the general purpose backend 120. In step S210, the bot joins the call. Upon receiving the user's request, the bot joins the Microsoft Teams call, enabling its integration into the meeting environment. Then the MS Teams Bot Backend 115 extracts S215 local date and time of participants. Upon joining the call, the backend component 115 of the MS Teams bot extracts S220 the local date and time information of each participant involved in the meeting. The MS Teams Bot Backend 115 also extracts S220 location of participants. Simultaneously, the MS Teams bot backend 115 extracts S220 the location data of participants, which may include geographical coordinates or other location identifiers.

In step S225, the MS Teams Bot Backend 115 Sends S225 the extracted metadata to the general purpose backend. The extracted metadata, comprising local date and time and participant locations, is transmitted S225 from the MS Teams bot backend 115 to the general purpose backend 120 for further processing and storage S230 in the datastore 125. The MS Teams 105 Continuously Sends S235 Audio Stream per Participant. Throughout the duration of the meeting, MS Teams 105 continuously streams S235 audio data from each participant participating in the call. The MS Teams Bot Backend 115 sends S240 the extracted audio metadata to the general purpose backend 120. The backend of the MS Teams bot 1215 continuously extracts audio metadata such as pitch, volume, and rate of speaking from the audio streams of each participant. This extracted audio metadata is then transmitted S240 to the general purpose backend 120 for subsequent analysis and to the datastore 125 for storage S245.

The MS Teams Bot Backend 115 continuously calculates S250 diarization. Diarization is the process of segmenting audio data to identify individual speakers is continuously calculated S250 by the backend component of the MS Teams bot 115. The MS Teams Bot Backend 115 sends S255 calculated diarization to the general purpose backend 120. The calculated diarization information, which delineates individual speakers and their respective speech segments, is sent from the MS Teams bot backend 115 to the general purpose backend 120 for further analysis and to the datastore 125 for storage S260.

In Step S270, the UI 110 Continuously Polls for Diarization from General Purpose Backend 120. The user interface (UI) component 110 continuously polls the general purpose backend 120 to retrieve the latest diarization information stored in the datastore 125. This information may be loaded S265 from the datastore 125 as needed.

The UI 110 Calculates S275 Key Performance Indicators (KPIs) based on received diarization. Upon receiving the diarization data, the UI 110 calculates S275 key performance indicators (KPIs) such as participant speaking time, contribution levels, and other relevant metrics based on the identified speaker segments. Then the UI 110 Visualizes S280 calculated KPIs and diarization. Finally, the UI component 110 visualizes S280 the calculated KPIs and diarization information in an easily interpretable format, such as graphs, charts, or other visualization tools, providing users with valuable insights into participant behavior and meeting dynamics. The UI component 110 additionally furnishes meeting participants and third-parties with real-time guidance, aiding in enhancing the meeting's success rate.

This detailed description of process 200 illustrates for analyzing online meeting metadata within the context of a Microsoft Teams call, with potential applicability to other online meeting platforms.

As described herein, the processes 100 and 200 for generating and analyzing metadata for online meetings is performed in real-time as the meeting is occurring to allow for real-time analysis of the meeting. This real-time analysis allows for facilitators to make changes in the meeting as the meeting is occurring to ensure that the participants are all able to participate.

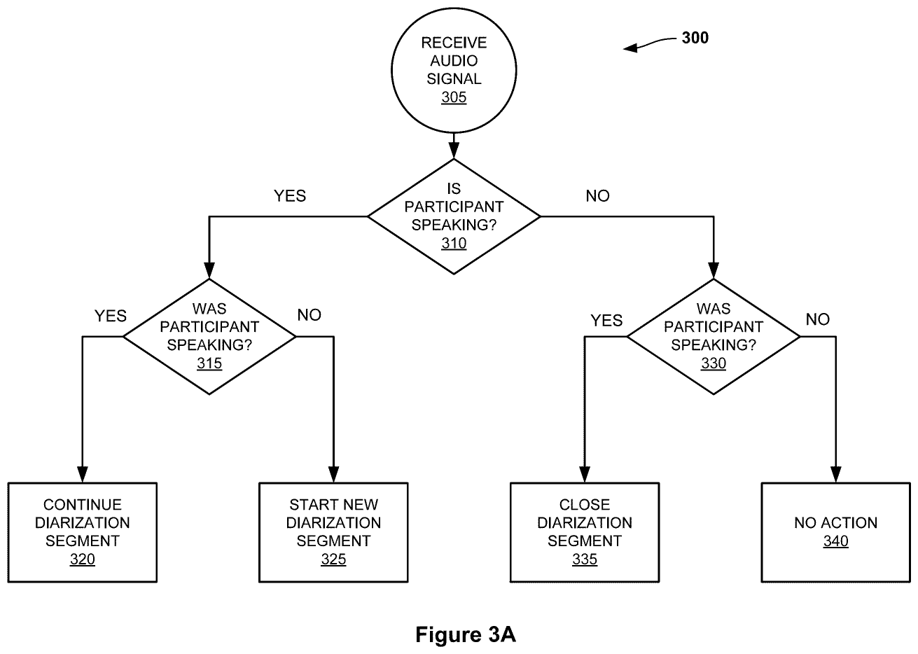

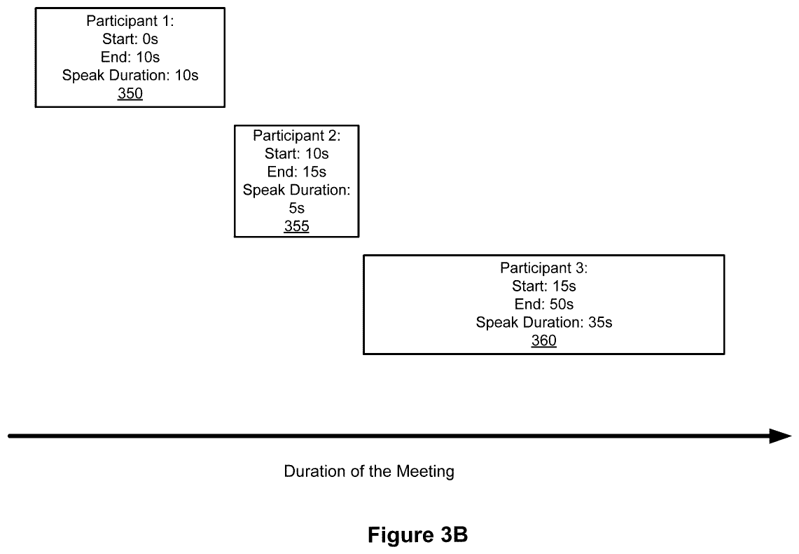

FIG. 3A illustrates a flow diagram of a process 300 for diarization in the context of online meeting analysis in real-time, in accordance with at least one embodiment of this disclosure. For this discussion diarization is the process of segmenting audio data to identify individual speakers and to enable the extraction of valuable insights into participant behavior and meeting dynamics. In the example embodiment, process 300 is performed by the provider specific backend 115 (shown in FIG. 1).

In the example embodiment, the provider specific backend 115 receives 305 the audio signals from online meeting platform 105 (shown in FIG. 1) capturing the speech of participants involved in the meeting. This is similar to step S150 (shown in FIG. 1) and step S235 (shown in FIG. 2). The rest of the steps of process 300 are part of set S165 (shown in FIG. 1) and step S250 (shown in FIG. 2).

The system employs advanced signal processing techniques and machine learning algorithms to determine whether a participant is speaking. This determination is based on factors such as amplitude, frequency, and duration of the audio signal. Upon receiving the audio signal, the provider specific backend 115 employs advanced signal processing techniques and machine learning algorithms to determine 310 whether a participant is speaking. If yes, the provider specific backend 115 checks 315 if participant was speaking before. If yes, the provider specific backend 115 continues 320 the current diarization segment for that participant. If the participant was not speaking, then the provider specific backend 115 starts 325 a new diarization segment for that participant. If the participant is not speaking, the provider specific backend 115 checks 330 if participant was speaking before. If yes, the provider specific backend 115 closes 335 the current diarization segment for that participant. If no one was speaking before, the provider specific backend 115 takes 340 no action.

In the example embodiment, the determination if the Participant is Speaking is done with state of the art “Voice activity detection” mechanisms and programs.

By dynamically adjusting diarization segments based on participant speech activity, the system improves the accuracy and efficiency of online meeting analysis. Additionally, real-time diarization and analysis of meeting metadata enables the system to provide timely insights into participant behavior and meeting dynamics, enhancing the overall effectiveness of the online meeting analysis process.

FIG. 3B illustrates a graph of diarization as provided by process 300 (shown in FIG. 3). The first segment 350 shows that the first participant spoke for 10 seconds. The second segment 355 shows that the second participant spoke for five seconds. And the third segment shows 35 seconds. In some embodiments, there may be blank areas were no participant spoke. In other embodiments, there may be multiple segments for the same participant.

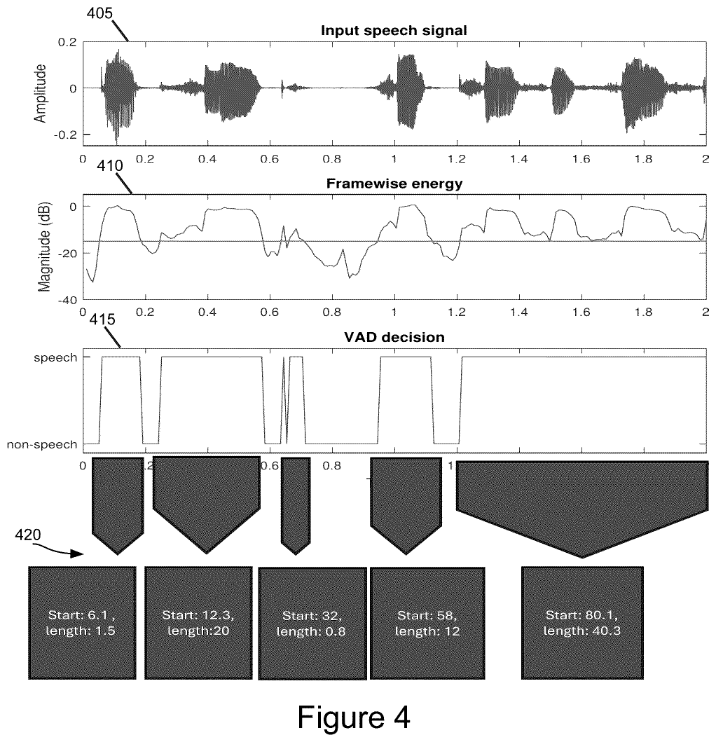

FIG. 4 illustrates the flow of an online meeting being analyzed by the processes 100-300 (shown in FIGS. 1-3A). A first graph 405 illustrates the amplitude of the participant speaking. A second graph 410 illustrates the magnitude of the participant speaking. A third graph 415 illustrates detecting period so speech and no speech. The last section 420 shows the various segments that were determined for diarization.

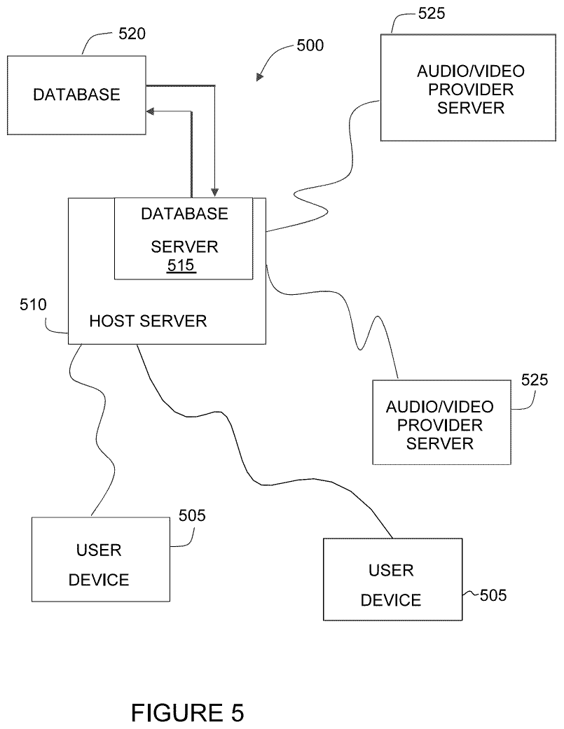

FIG. 5 illustrates an exemplary computer system 500 for performing the processes 100-300 (shown in FIGS. 1-3A). In the exemplary embodiment, the system 500 is used for generating and analyzing metadata for online meetings.

As described below in more detail, the Host server 510 may be programmed for generating and analyzing metadata for online meetings. In some embodiments, the host server 510 may be programmed to: a) receive at least one stream of at least one of audio and video of an online meeting, wherein the at least one stream includes one or more participants participating in the online meeting; b) extract a plurality of metadata from the at least one stream; c) perform diarization on the at least one stream and the plurality of metadata the at least one stream to generate diarization information, wherein the diarization information includes information about participation for the one or more participants in the online meeting; d) analyzing the diarization information to calculate one or more key performance indicators; and e) generate visualization of the key performance indicators to be displayed to one or more participants in the online meeting.

In the example embodiment, user devices 505 are computers that include a web browser or a software application, which enables user devices 505 to communicate with host server 510 using the Internet, a local area network (LAN), or a wide area network (WAN). In some embodiments, the user devices 505 are communicatively coupled to the Internet through many interfaces including, but not limited to, at least one of a network, such as the Internet, a LAN, a WAN, or an integrated services digital network (ISDN), a dial-up-connection, a digital subscriber line (DSL), a cellular phone connection, a satellite connection, and a cable modem. User devices 505 can be any device capable of accessing a network, such as the Internet, including, but not limited to, a desktop computer, a laptop computer, a personal digital assistant (PDA), a cellular phone, a smartphone, a tablet, a phablet, wearable electronics, smart watch, virtual headsets or glasses (e.g., AR (augmented reality), VR (virtual reality), MR (mixed reality), or XR (extended reality) headsets or glasses), chat bots, voice bots, ChatGPT bots or ChatGPT-based bots, or other web-based connectable equipment or mobile devices.

In the example embodiment, the host server 510 is a computer that include a web browser or a software application, which enables host server 510 to communicate with user devices 505 using the Internet, a local area network (LAN), or a wide area network (WAN). Furthermore, the host server 510 may include a host UI 110, a provider specific backend 115, a host general purpose backend 120 and at least one host datastore 125 (all shown in FIG. 1). In some embodiments, the host server 510 is communicatively coupled to the Internet through many interfaces including, but not limited to, at least one of a network, such as the Internet, a LAN, a WAN, or an integrated services digital network (ISDN), a dial-up-connection, a digital subscriber line (DSL), a cellular phone connection, a satellite connection, and a cable modem. The host server 510 can be any device capable of accessing a network, such as the Internet, including, but not limited to, a desktop computer, a laptop computer, a personal digital assistant (PDA), a cellular phone, a smartphone, a tablet, a phablet, wearable electronics, smart watch, virtual headsets or glasses (e.g., AR (augmented reality), VR (virtual reality), MR (mixed reality), or XR (extended reality) headsets or glasses), chat bots, voice bots, ChatGPT bots or ChatGPT-based bots, or other web-based connectable equipment or mobile devices.

A database server 515 is communicatively coupled to a database 520 that stores data. In one embodiment, the database 520 is a database that includes diarization data and metadata from online meetings. In some embodiments, the database 520 is stored remotely from the host server 510. In some embodiments, the database 520 is decentralized. In the example embodiment, a person can access the database 520 via the user devices 505 by logging onto host server 510. In some embodiments, the database 520 is similar to, or in communication with, the datastore 125.

Audio/Video provider servers 525 may be any third-party server to provide information that host server 510 is in communication with that provides additional functionality and/or information to host server 510. For example, Audio/Video provider servers 525 may be similar to online meeting providers 105 (shown in FIG. 1). In the example embodiment, Audio/Video provider servers 525 are computers that include a web browser or a software application, which enables Audio/Video provider servers 525 to communicate with the host server 510 using the Internet, a local area network (LAN), or a wide area network (WAN).

In some embodiments, the Audio/Video provider servers 525 are communicatively coupled to the Internet through many interfaces including, but not limited to, at least one of a network, such as the Internet, a LAN, a WAN, or an integrated services digital network (ISDN), a dial-up-connection, a digital subscriber line (DSL), a cellular phone connection, a satellite connection, and a cable modem. Audio/Video provider servers 525 can be any device capable of accessing a network, such as the Internet, including, but not limited to, a desktop computer, a laptop computer, a personal digital assistant (PDA), a cellular phone, a smartphone, a tablet, a phablet, wearable electronics, smart watch, virtual headsets or glasses (e.g., AR (augmented reality), VR (virtual reality), MR (mixed reality), or XR (extended reality) headsets or glasses), chat bots, voice bots, ChatGPT bots or ChatGPT-based bots, or other web-based connectable equipment or mobile devices.

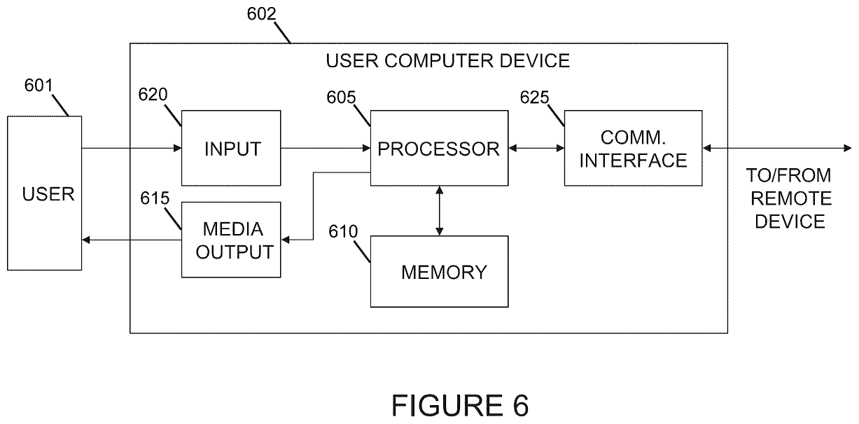

FIG. 6 depicts an exemplary configuration 600 of user computer device 602, in accordance with one embodiment of the present disclosure. In the exemplary embodiment, user computer device 602 may be similar to, or the same as, user device 505 (shown in FIG. 5). User computer device 602 may be operated by a user 601.

User computer device 602 may include a processor 605 for executing instructions. In some embodiments, executable instructions may be stored in a memory area 610. Processor 605 may include one or more processing units (e.g., in a multi-core configuration). Memory area 610 may be any device allowing information such as executable instructions and/or transaction data to be stored and retrieved. Memory area 610 may include one or more computer readable media.

User computer device 602 may also include at least one media output component 615 for presenting information to user 601. Media output component 615 may be any component capable of conveying information to user 601. In some embodiments, media output component 615 may include an output adapter (not shown) such as a video adapter and/or an audio adapter. An output adapter may be operatively coupled to processor 605 and operatively couplable to an output device such as a display device (e.g., a cathode ray tube (CRT), liquid crystal display (LCD), light emitting diode (LED) display, or “electronic ink” display) or an audio output device (e.g., a speaker or headphones).

In some embodiments, media output component 615 may be configured to present a graphical user interface (e.g., a web browser and/or a client application) to user 601. A graphical user interface may include, for example, an interface for viewing items of information provided by the host server 510 (shown in FIG. 5). In some embodiments, user computer device 602 may include an input device 620 for receiving input from user 601. User 601 may use input device 620 to, without limitation, provide information either through speech or typing.

Input device 620 may include, for example, a keyboard, a pointing device, a mouse, a stylus, a touch sensitive panel (e.g., a touch pad or a touch screen), a gyroscope, an accelerometer, a position detector, a biometric input device, and/or an audio input device. A single component such as a touch screen may function as both an output device of media output component 615 and input device 620.

User computer device 602 may also include a communication interface 625, communicatively coupled to a remote device such as host server 510. Communication interface 625 may include, for example, a wired or wireless network adapter and/or a wireless data transceiver for use with a mobile telecommunications network.

Stored in memory area 610 are, for example, computer readable instructions for providing a user interface to user 601 via media output component 615 and, optionally, receiving and processing input from input device 620. A user interface may include, among other possibilities, a web browser and/or a client application. Web browsers enable users, such as user 601, to display and interact with media and other information typically embedded on a web page or a website from Host server 510. A client application may allow user 601 to interact with, for example, Host server 510. For example, instructions may be stored by a cloud service, and the output of the execution of the instructions sent to the media output component 615.

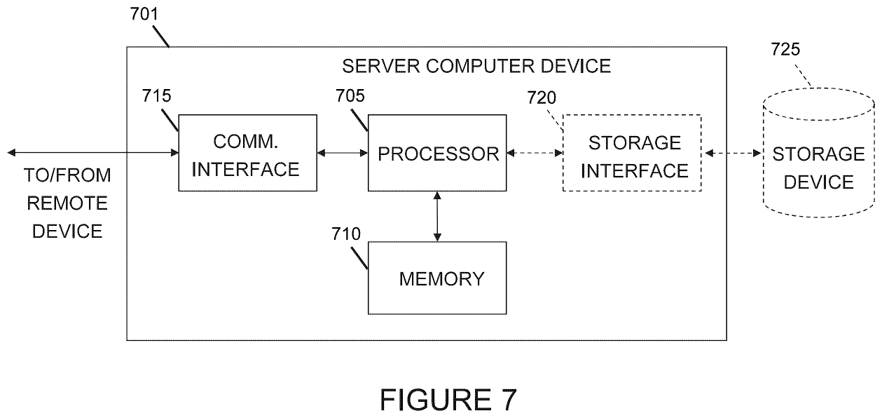

FIG. 7 depicts an exemplary configuration 700 of a server computer device 701, in accordance with one embodiment of the present disclosure. In the exemplary embodiment, server computer device 701 may be similar to, or the same as, online meeting provider 105, host UI 110, a provider specific backend 115, a host general purpose backend 120 (all shown in FIG. 1), host server 510, database server 515, and audio/video provider server 525 (all shown in FIG. 5). Server computer device 701 may also include a processor 705 for executing instructions. Instructions may be stored in a memory area 710. Processor 705 may include one or more processing units (e.g., in a multi-core configuration).

Processor 705 may be operatively coupled to a communication interface 715 such that server computer device 701 is capable of communicating with a remote device such as another server computer device 701, Host server 510, audio/video provider server 525, and user devices 505 (shown in FIG. 5) (for example, using wireless communication or data transmission over one or more radio links or digital communication channels). For example, communication interface 715 may receive input from user devices 505 via the Internet, as illustrated in FIG. 5.

Processor 705 may also be operatively coupled to a storage device 725. Storage device 725 may be any computer-operated hardware suitable for storing and/or retrieving data, such as, but not limited to, data associated with one or more models. In some embodiments, storage device 725 may be integrated in server computer device 701. For example, server computer device 701 may include one or more hard disk drives as storage device 725.

In other embodiments, storage device 725 may be external to server computer device 701 and may be accessed by a plurality of server computer devices 701. For example, storage device 725 may include a storage area network (SAN), a network attached storage (NAS) system, and/or multiple storage units such as hard disks and/or solid-state disks in a redundant array of inexpensive disks (RAID) configuration.

In some embodiments, processor 705 may be operatively coupled to storage device 725 via a storage interface 720. Storage interface 720 may be any component capable of providing processor 705 with access to storage device 725. Storage interface 720 may include, for example, an Advanced Technology Attachment (ATA) adapter, a Serial ATA (SATA) adapter, a Small Computer System Interface (SCSI) adapter, a RAID controller, a SAN adapter, a network adapter, and/or any component providing processor 705 with access to storage device 725.

Processor 705 may execute computer-executable instructions for implementing aspects of the disclosure. In some embodiments, the processor 705 may be transformed into a special purpose microprocessor by executing computer-executable instructions or by otherwise being programmed. For example, the processor 705 may be programmed with the instruction such as illustrated in FIGS. 1-3A.

In at least one embodiment, the host system receives at least one stream of at least one of audio and video of an online meeting. The at least one stream includes a plurality of participants participating in the online meeting.

In at least one embodiment, the host system extracts a plurality of metadata from the at least one stream.

In at least one embodiment, the host system performs diarization on the at least one stream and the plurality of metadata the at least one stream to generate diarization information. The diarization information includes information about participation for the plurality of participants in the online meeting. In some embodiments, the online meeting is occurring in real-time.

In at least one embodiment, the host system analyzes the diarization information to calculate one or more key performance indicators (KPIs). In some embodiments, the one or more key performance indicators include a group interaction intensity based on an average number of interactions for the plurality of participants in the online meeting. In some other embodiments, the one or more key performance indicators include a number of times that each participant spoke, a total number of turns taken by all participants, and an average distance of each participant from the maximum number of turn taking performed by a participant. In other embodiments, the one or more key performance indicators include at least one of a group interaction intensity based on an average number of interactions for the plurality of participants in the online meeting, a number of times that each participant spoke, a total number of turns taken by all participants, and an average distance of each participant from the maximum number of turn taking performed by a participant.

In at least one embodiment, the host system determines a recommendation to change the one or more KPIs. In some embodiments, the host system determines a recommendation to change the one or more KPIs by executing a model trained using artificial intelligence. In some embodiments, the model is trained using historical success information.

In some embodiments, the host system determines a strength of the recommendation based on at least one of the KPIs. The host system generates text for the recommendation based on the determined strength of the recommendation. In some embodiments, the strength of the recommendation is determined by comparing the at least one of the KPIs to a predetermined threshold. In these embodiments, the host system generates affirmative text if the at least one of the KPIs is >66% of the predetermined threshold. In these embodiments, the host system generates improving text if the at least one of the KPIs is >33% of the predetermined threshold. In some embodiments, the host system generates critical text if the at least one of the KPIs is <33% of the predetermined threshold. One having skill in the art would understand that these thresholds could be adjusted based on needs and the associated KPIs.

In at least one embodiment, the host system generates visualization of at least one of the key performance indicators and the recommendation to be displayed to one or more participants in the online meeting. In some embodiments, the host system generates a user interface to display a visual representation of one or more of the KPIs as a weather symbol analogy.

In some embodiments, the key performance indicators are calculated subsequent to completion of the online meeting and transmitted to one or more participants of the online meeting.

In some embodiments, the host system includes a meeting metadata capture module configured to collect data generated during online meetings, including participant speaking patterns and audio characteristics. The host system also includes a data processing and analysis module configured to process the captured metadata using machine learning algorithms and statistical techniques to extract insights regarding participant behavior and group dynamics and generate meeting success indicators. The host system further includes a reporting and visualization module configured to generate reports and visualizations summarizing the findings from the data analysis. In addition the host system includes a recommendation module configured to provide recommendations to increase the overall success of the meeting based on scientific findings in real time during the meeting and/or after the meeting as a summary report.

In some embodiments, the meeting metadata capture module further captures metadata related to participant location and date/time of participation.

In some embodiments, the data processing and analysis module employs diarization techniques to segment the audio data. Based on this data metrics are being calculated that have shown to be key meeting success indicators in scientific research in a variety of meeting contexts.

In some embodiments, the reporting and visualization module generates visualizations such as graphs and charts to present the analyzed data in an easily interpretable format.

In some embodiments, the reporting and visualization module furnishes meeting participants and third-parties with real-time guidance or analysis after the meeting, aiding in enhancing meeting success rates.

In some embodiments, the host system is configured for enhancing team creativity during online meetings. The host system includes an IPT (Intensity of Group Interaction) monitor for measuring interaction levels among participants. The host system also includes s component for generating text feedback based on IPT values, where the text is categorized as affirmative, improving, or critical depending on predefined thresholds. The host system further includes a state space generator that includes the generated text and metadata of the meeting. In addition, the host system includes an AI agent that selects wording with a high probability of improving meeting success. Moreover, the host system includes an action space selector containing different text wordings for each category. Furthermore, the host system includes an output text generator for delivering the selected text to the meeting moderator or leader.

In these embodiments, the IPT monitor is configured to generate: Affirmative text if the IPT is greater than 66% of a maximum predefined value; Improving text if the IPT is greater than 33% and less than or equal to 66% of the maximum value; and Critical text if the IPT is less than or equal to 33% of the maximum value. One having skill in the art would understand that these thresholds could be adjusted based on needs and the associated KPIs.

In these embodiments, the state space generator compiles metadata including participant details, speaking patterns, engagement levels, and the generated feedback text.

In these embodiments, the AI agent utilizes machine learning algorithms to analyze the state space and select wording that enhances the likelihood of successful meeting outcomes.

In these embodiments, the action space selector contains predefined text wordings for affirmative, improving, and critical feedback categories, and selects the most appropriate text based on the AI agent's recommendation.

In these embodiments, the host system further includes an interface for delivering the output text to the meeting moderator or leader in real-time during the meeting.

In some embodiments, the host system for enhancing team creativity during online meetings includes: An IPT (Intensity of Group Interaction) monitor for measuring interaction levels among participants; A component that generates feedback based on IPT values, categorized as affirmative, improving, or critical according to predefined thresholds; and An output text generator that produces and delivers the feedback text to the meeting moderator or leader.

In these embodiments, the IPT monitor generates: Affirmative feedback if the IPT is greater than 66% of a maximum predefined value; Improving feedback if the IPT is greater than 33% and less than or equal to 66% of the maximum value; and Critical feedback if the IPT is less than or equal to 33% of the maximum value.

In these embodiments, the output text generator produces feedback messages that are tailored to provide constructive suggestions or affirmations to the meeting moderator or leader.

In these embodiments, the feedback messages are designed to be actionable, helping to enhance meeting dynamics and increase team creativity by guiding the moderator or leader.

In these embodiments, the predefined thresholds for categorizing IPT values are adjustable based on meeting goals, participant characteristics, or other contextual factors.

In some embodiments, a dashboard system for enhancing team creativity during online meetings includes A display of real-time interaction metrics, including turn-taking frequency, speaking time distribution, and Intensity of Group Interaction (IPT); Feedback indicators that use color-coding to represent the current state of team creativity; A recommendations panel providing actionable suggestions to improve meeting dynamics; and Affirmative messages and alerts based on the current data to guide the meeting moderator or leader.

In these embodiments, the feedback indicators include: A green indicator for high team creativity; A yellow indicator for moderate creativity with room for improvement; and A red indicator for low creativity requiring significant adjustments.

The recommendations panel provides suggestions such as: Encouraging quieter participants to speak more frequently; Managing dominant speakers to balance the conversation; and Adjusting the pacing of the meeting to enhance engagement.

In these embodiments, the dashboard further includes a section for displaying historical data and trends, allowing the tracking of changes in team dynamics over time.

In these embodiments, users can customize the display to focus on specific metrics or areas of interest, tailoring the feedback and recommendations to the needs of the team and meeting objectives.

In still further embodiments, the host system provides for improving meeting performance. The host system includes A KPI analysis module configured to monitor and analyze meeting productivity, creativity, and time efficiency in real time; A metadata analysis engine configured to process and correlate meeting metadata with the monitored KPIs; A behavioral change calculation module configured to determine potential behavioral changes to improve meeting performance based on the analyzed metadata and KPIs; A recommendation generator configured to formulate and deliver actionable recommendations to meeting leaders and moderators, offering multiple options and using a relatable tonality; and A self-learning algorithm employing deep reinforcement learning to adapt recommendations based on their effectiveness in specific social contexts over time.

In these embodiments, the KPI analysis module collects data from meeting interactions, participant behavior, and meeting outcomes.

In these embodiments, the metadata analysis engine processes information including meeting duration, participant engagement levels, speech patterns, and interaction frequencies.

In these embodiments, the behavioral change calculation module considers participant roles, meeting objectives, and historical meeting data in its calculations.

In these embodiments, the recommendation generator provides recommendations in a user-friendly manner, based on proven team coaching techniques.

In these embodiments, the self-learning algorithm continuously adapts recommendations using deep reinforcement learning based on their effectiveness in specific social contexts.

In some embodiments, a system for improving meeting performance, includes: A KPI analysis module configured to monitor and analyze meeting productivity, creativity, and time efficiency in real time; A metadata analysis engine configured to process and correlate meeting metadata with the monitored KPIs; A behavioral change calculation module configured to determine potential behavioral changes to improve meeting performance based on the analyzed metadata and KPIs; A recommendation generator configured to formulate and deliver actionable recommendations to meeting leaders and moderators, offering multiple options and using a relatable tonality; and A self-learning algorithm employing deep reinforcement learning to adapt recommendations based on their effectiveness in specific social contexts over time.

In these embodiments, the KPI analysis module collects data from meeting interactions, participant behavior, and meeting outcomes.

In these embodiments, the metadata analysis engine processes information including meeting duration, participant engagement levels, speech patterns, and interaction frequencies.

In these embodiments, the behavioral change calculation module considers participant roles, meeting objectives, and historical meeting data in its calculations.

In these embodiments, the recommendation generator provides recommendations in a user-friendly manner, based on proven team coaching techniques.

In these embodiments, the self-learning algorithm continuously adapts recommendations using deep reinforcement learning based on their effectiveness in specific social contexts.

In some embodiments, a method for improving meeting performance includes: Monitoring and analyzing meeting productivity, creativity, and time efficiency in real time; Processing and correlating meeting metadata with the monitored KPIs; Determining potential behavioral changes to improve meeting performance based on the analyzed metadata and KPIs; Formulating and delivering actionable recommendations to meeting leaders and moderators, offering multiple options and using a relatable tonality and Adapting recommendations over time based on their effectiveness in specific social contexts using a self-learning algorithm employing deep reinforcement learning.

In these embodiments, the monitoring and analyzing KPIs involves collecting data from meeting interactions, participant behavior, and meeting outcomes.

In these embodiments, the processing metadata includes analyzing meeting duration, participant engagement levels, speech patterns, and interaction frequencies.

In these embodiments, the determining behavioral changes considers participant roles, meeting objectives, and historical meeting data.

In these embodiments, the formulating recommendations involves using proven team coaching techniques to provide actionable and relatable suggestions.

In these embodiments, the self-learning algorithm employs deep reinforcement learning to continuously adapt recommendations based on their effectiveness in specific social contexts.

In one embodiment, a system for recommending improvements in team productivity during online meetings includes: A metadata capture module configured to collect meeting metadata, including participant speaking patterns and audio characteristics; and A data processing and analysis module.

In these embodiments, the data processing and analysis module is configured to: a. Segment the collected audio data using diarization techniques; b. Calculate turn taking (TT) metrics for each participant; and c. Calculate the average distance (AvgDis) of each participant's turn taking from the average turn taking.

In these embodiments, the recommendation generation module is configured to: a. Categorize the AvgDis into performance categories; b. Generate textual feedback based on the categorized AvgDis, including: i. Affirmative feedback if the AvgDis is greater than 66% of the maximum possible AvgDis; ii. Constructive feedback if the AvgDis is greater than 33% and less than or equal to 66% of the maximum possible AvgDis; iii. Critical feedback if the AvgDis is less than or equal to 33% of the maximum possible AvgDis; and an output module configured to deliver the generated textual feedback to meeting participants. One having skill in the art would understand that these thresholds could be adjusted based on needs and the associated KPIs.

In some embodiments, a method for analyzing and improving team productivity during online meetings includes: Initiating the process by capturing meeting metadata, including participant speaking patterns and audio characteristics; Processing the captured metadata to: a. Segment the audio data using diarization techniques; b. Calculate turn taking (TT) metrics for each participant; c. Calculate the average distance (AvgDis) of each participant's turn taking from the average turn taking; Categorizing the AvgDis into performance categories based on predefined thresholds: a. Providing affirmative feedback if the AvgDis is greater than 66% of the maximum possible AvgDis; b. Providing constructive feedback if the AvgDis is greater than 33% and less than or equal to 66% of the maximum possible AvgDis; c. Providing critical feedback if the AvgDis is less than or equal to 33% of the maximum possible AvgDis; and Delivering the appropriate textual feedback to meeting participants based on the categorized AvgDis.

In some embodiments, a non-transitory computer-readable medium storing instructions that, when executed by a processor, cause the processor to perform a method for recommending improvements in team productivity during online meetings. The method includes: Capturing meeting metadata, including participant speaking patterns and audio characteristics; Processing the captured metadata to: a. Segment the audio data using diarization techniques; b. Calculate turn taking (TT) metrics for each participant; c. Calculate the average distance (AvgDis) of each participant's turn taking from the average turn taking; Categorizing the AvgDis into performance categories based on predefined thresholds: a. Generating affirmative feedback if the AvgDis is greater than 66% of the maximum possible AvgDis; b. Generating constructive feedback if the AvgDis is greater than 33% and less than or equal to 66% of the maximum possible AvgDis; c. Generating critical feedback if the AvgDis is less than or equal to 33% of the maximum possible AvgDis; and Delivering the generated textual feedback to meeting participants based on the categorized AvgDis.

In some embodiments, a system for providing dynamic feedback to improve team productivity during online meetings includes: A metadata capture module configured to collect meeting metadata without capturing the content of the meeting; A data processing module configured to: a. Use diarization techniques to segment the collected audio data; b. Calculate turn taking (TT) metrics for each meeting participant; c. Compute the average distance (AvgDis) of each participant's turn taking from the average turn taking; A decision module configured to: a. Categorize the AvgDis into performance categories based on thresholds: i. Greater than 66% of the maximum possible AvgDis for affirmative feedback; ii. Greater than 33% and less than or equal to 66% of the maximum possible AvgDis for constructive feedback; iii. Less than or equal to 33% of the maximum possible AvgDis for critical feedback; and an output module configured to: a. Generate and deliver the appropriate textual feedback based on the categorized AvgDis; b. Provide feedback in a user-friendly manner.

In some embodiments, a method for providing real-time feedback to improve team productivity during online meetings, includes: Continuously capturing meeting metadata, including participant speaking patterns and audio characteristics; Continuously processing the captured metadata to: a. Segment the audio data using diarization techniques; b. Calculate turn taking (TT) metrics for each participant in real-time; c. Continuously compute the average distance (AvgDis) of each participant's turn taking from the average turn taking; Continuously categorizing the AvgDis into performance categories based on predefined thresholds: a. Generating real-time affirmative feedback if the AvgDis is greater than 66% of the maximum possible AvgDis; b. Generating real-time constructive feedback if the AvgDis is greater than 33% and less than or equal to 66% of the maximum possible AvgDis; c. Generating real-time critical feedback if the AvgDis is less than or equal to 33% of the maximum possible AvgDis; and Continuously delivering the appropriate textual feedback to meeting participants based on the real-time categorized AvgDis.

In some embodiments, a system for recommending improvements in team productivity during online meetings using an AI agent, includes: A metadata capture module configured to collect meeting metadata, including participant speaking patterns and audio characteristics; A data processing and analysis module configured to: a. Segment the collected audio data using diarization techniques; b. Calculate turn taking (TT) metrics for each participant; c. Calculate the average distance (AvgDis) of each participant's turn taking from the average turn taking; A recommendation generation module configured to: a. Categorize the AvgDis into performance categories; b. Generate textual feedback categories based on the categorized AvgDis, including: i. Affirmative feedback if the AvgDis is greater than 66% of the maximum possible AvgDis; ii. Constructive feedback if the AvgDis is greater than 33% and less than or equal to 66% of the maximum possible AvgDis; iii. Critical feedback if the AvgDis is less than or equal to 33% of the maximum possible AvgDis; A state space module configured to compile the identified feedback category and all meeting metadata; An AI agent configured to: a. Process the state space; b. Select the optimal wording for the feedback from an action space containing different text wordings for each feedback category; c. Choose the wording that has the highest probability of improving meeting success; and An output module configured to deliver the optimized textual feedback to meeting participants.

In some embodiments, a method for analyzing and improving team productivity during online meetings using an AI agent, includes: Initiating the process by capturing meeting metadata, including participant speaking patterns and audio characteristics; Processing the captured metadata to: a. Segment the audio data using diarization techniques; b. Calculate turn taking (TT) metrics for each participant; c. Calculate the average distance (AvgDis) of each participant's turn taking from the average turn taking; Categorizing the AvgDis into performance categories based on predefined thresholds: a. Providing affirmative feedback if the AvgDis is greater than 66% of the maximum possible AvgDis; b. Providing constructive feedback if the AvgDis is greater than 33% and less than or equal to 66% of the maximum possible AvgDis; c. Providing critical feedback if the AvgDis is less than or equal to 33% of the maximum possible AvgDis; Compiling the identified feedback category and all meeting metadata into a state space; Using an AI agent to: a. Process the state space; b. Select the optimal wording for the feedback from an action space containing different text wordings for each feedback category; c. Choose the wording that has the highest probability of improving meeting success; and Delivering the optimized textual feedback to meeting participants based on the AI agent's selection.

In some embodiments, the non-transitory computer-readable medium storing instructions that, when executed by a processor, cause the processor to perform a method for recommending improvements in team productivity during online meetings using an AI agent, the method comprising: Capturing meeting metadata, including participant speaking patterns and audio characteristics; Processing the captured metadata to: a. Segment the audio data using diarization techniques; b. Calculate turn taking (TT) metrics for each participant; c. Calculate the average distance (AvgDis) of each participant's turn taking from the average turn taking; Categorizing the AvgDis into performance categories based on predefined thresholds: a. Generating affirmative feedback if the AvgDis is greater than 66% of the maximum possible AvgDis; b. Generating constructive feedback if the AvgDis is greater than 33% and less than or equal to 66% of the maximum possible AvgDis; c. Generating critical feedback if the AvgDis is less than or equal to 33% of the maximum possible AvgDis; Compiling the identified feedback category and all meeting metadata into a state space; Using an AI agent to: a. Process the state space; b. Select the optimal wording for the feedback from an action space containing different text wordings for each feedback category; c. Choose the wording that has the highest probability of improving meeting success; and Delivering the optimized textual feedback to meeting participants based on the AI agent's selection.

In some embodiments, the system for providing dynamic feedback to improve team productivity during online meetings using an AI agent, includes: A metadata capture module configured to collect meeting metadata without capturing the content of the meeting; A data processing module configured to: a. Use diarization techniques to segment the collected audio data; b. Calculate turn taking (TT) metrics for each meeting participant; c. Compute the average distance (AvgDis) of each participant's turn taking from the average turn taking; and A decision module configured to: a. Categorize the AvgDis into performance categories based on thresholds: i. Greater than 66% of the maximum possible AvgDis for affirmative feedback; ii. Greater than 33% and less than or equal to 66% of the maximum possible AvgDis for constructive feedback; iii. Less than or equal to 33% of the maximum possible AvgDis for critical feedback.

In some embodiments, the system for adaptive recommendation generation in online meetings using deep reinforcement learning, including: A metadata capture module configured to collect meeting metadata, including participant information, speaking patterns, and feedback; A state space module configured to: a. Compile and continuously update the state space with meeting metadata and feedback; An AI agent module configured to: a. Operate within a deep reinforcement learning framework; b. Analyze success information indicating how meeting KPIs evolved after a recommendation was shown; c. Adapt the action space based on the analyzed success information; An action space module configured to: a. Contain different textual wordings and recommendations categorized as affirmative, improving, or critical; b. Update the probability distribution of selecting specific wordings or recommendations based on the AI agent's adaptation; and A timing module configured to trigger the adaptation process dt seconds after a recommendation is shown.

In some embodiments, the method for adaptive recommendation generation in online meetings using deep reinforcement learning, including: Initiating the process by capturing meeting metadata, including participant information, speaking patterns, and feedback; Compiling and continuously updating the state space with meeting metadata and feedback; Triggering the adaptation process dt seconds after displaying a recommendation; Analyzing success information indicating how meeting KPIs evolved after the recommendation; Adapting the action space based on the analyzed success information, including: a. Modifying the probability distribution of selecting specific wordings or recommendations; b. Learning from the outcomes of previous recommendations to optimize future suggestions; and Concluding the process with an updated action space for future recommendations.

In some embodiments, the non-transitory computer-readable medium storing instructions that, when executed by a processor, cause the processor to perform a method for adaptive recommendation generation in online meetings using deep reinforcement learning, the method comprising: Capturing meeting metadata, including participant information, speaking patterns, and feedback; Compiling and continuously updating the state space with meeting metadata and feedback; Triggering the adaptation process dt seconds after displaying a recommendation; Analyzing success information indicating how meeting KPIs evolved after the recommendation; Adapting the action space based on the analyzed success information, including: a. Modifying the probability distribution of selecting specific wordings or recommendations; b. Learning from the outcomes of previous recommendations to optimize future suggestions; and Concluding the process with an updated action space for future recommendations.

In some embodiments, the system for providing dynamic feedback adaptation to improve team productivity during online meetings using deep reinforcement learning, includes: A metadata capture module configured to collect meeting metadata, including participant information and speaking patterns; A state space module configured to compile and continuously update the state space with meeting metadata and feedback; An AI agent module configured to: a. Operate within a deep reinforcement learning framework; b. Analyze success information indicating how meeting KPIs evolved after a recommendation was shown; c. Adapt the action space based on the analyzed success information; An action space module configured to contain different textual wordings and recommendations categorized as affirmative, improving, or critical; A timing module configured to trigger the adaptation process dt seconds after a recommendation is shown; and An output module configured to deliver the optimized textual feedback to meeting participants based on the AI agent's adapted action space.

In some embodiments, the system includes: A user interface configured to display multiple recommendation options for improving team productivity during meetings; A recommendation engine configured to analyze meeting data in real-time and generate actionable guidance based on identified meeting challenges and performance metrics; An interaction module allowing meeting moderators or leaders to select and implement recommended actions from the displayed options; A feedback mechanism providing real-time updates and adjustments to recommendations based on ongoing meeting dynamics and outcomes; and The system wherein the recommendation engine utilizes historical meeting data and best practices in team collaboration to optimize the relevance and effectiveness of the recommendations displayed.

In some embodiments, the method includes: Displaying a user interface presenting multiple recommendation options for improving team productivity during meetings; Analyzing meeting data in real-time to identify meeting challenges and performance metrics; Generating actionable guidance based on the analyzed meeting data and identified challenges; Allowing interaction with the user interface to select and implement recommended actions; Providing real-time feedback on the effectiveness of implemented actions and adjusting recommendations based on ongoing meeting dynamics; and The method wherein the actionable guidance is derived from historical meeting data, real-time analysis, and best practices in team collaboration and meeting facilitation.

In some embodiments, a non-transitory computer-readable medium storing instructions that, when executed by a processor, cause the processor to perform: Displaying a user interface presenting multiple recommendation options for improving team productivity during meetings; Analyzing meeting data in real-time to identify meeting challenges and performance metrics; Generating actionable guidance based on the analyzed meeting data and identified challenges; Allowing interaction with the user interface to select and implement recommended actions; Providing real-time feedback on the effectiveness of implemented actions and adjusting recommendations based on ongoing meeting dynamics; and The instructions wherein the actionable guidance is derived from historical meeting data, real-time analysis, and best practices in team collaboration and meeting facilitation.

In one embodiment, a host system includes: A user interface presenting multiple recommendation options for improving team productivity during meetings; A recommendation engine analyzing meeting data in real-time to identify challenges and performance metrics; An interaction module enabling users to select and implement recommended actions; A feedback mechanism adjusting recommendations based on ongoing meeting dynamics and outcomes; and The system wherein the recommendation engine incorporates historical meeting data and best practices in team collaboration to optimize the relevance and effectiveness of recommendations displayed on the user interface.

In conclusion, the system and method for dynamic diarization and analysis of meeting metadata in online meeting analysis represent a significant advancement in the field of audio processing and online meeting analytics. The invention has numerous applications across various domains, including remote collaboration, communication analysis, and performance evaluation in virtual environments.

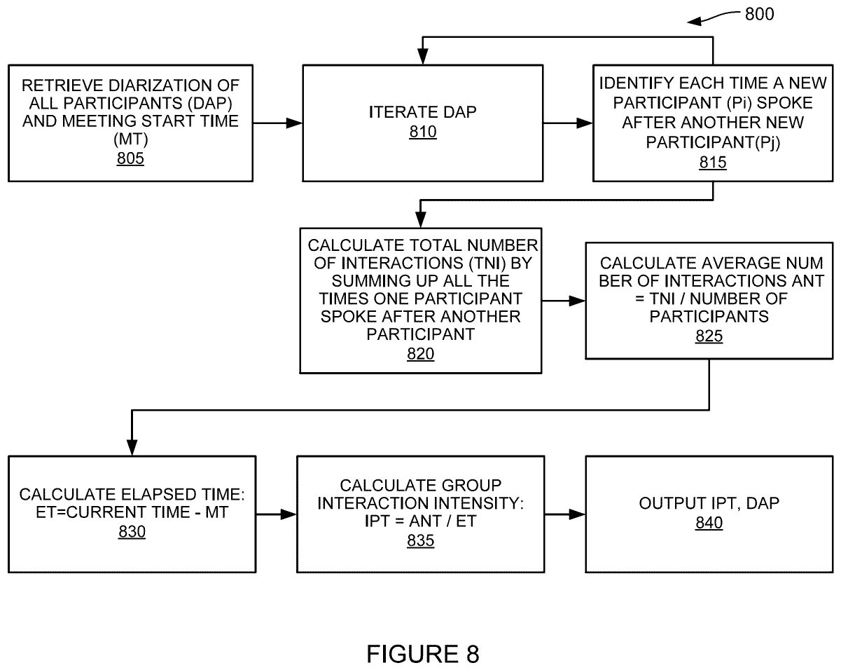

FIGS. 8-11 illustrate example processes for calculating Key Performance Indicators (KPIs) based on received diarization. In many embodiments, these processes occur during step S190 (shown in FIG. 1) and/or step S275 (shown in FIG. 2). In some embodiments, the processes shown in FIGS. 8-11 are performed in real-time, as the online meetings are occurring. In other embodiments, the processes shown in FIGS. 8-11 are performed offline, after the meeting has completed. In some embodiments, the KPIs introduced in FIGS. 8-11 cause one or more participants in the online meeting to change their behavior or request others to change their behavior. For example, the KPIs may indicate that one or more participants of the meeting have not spoken. This may cause a moderator, human or AI, to request that those one or more participants to speak next. The moderator may also adjust the order of speakers for the online meeting based on the KPIs.

FIG. 8 illustrates an example process 800 for calculating Key Performance Indicators (KPIs) based on received diarization. In the example embodiment, the steps of process 800 are performed by the UI 110, the provider specific backend 115, the host general purpose backend 120 (all shown in FIG. 1), and/or host server 510 (shown in FIG. 5). The steps of process 800 occur while processes 100 and/or 200 are occurring (shown in FIGS. 1 and 2, respectively). In many embodiments, process 800 occurs during step S190 (shown in FIG. 1) and/or step S275 (shown in FIG. 2). In step S805, diarization data of all meeting participants (DAP) is retrieved at a regular time intervals, such as a default interval of 0.5 seconds. The meeting start time (MT) is also retrieved S805. These may be retrieved S805 from the host datastore 125 (shown in FIG. 1). In steps S810 and S815, the diarization data structure for each participant is traversed by an algorithm that counts each time a participant (Pi) spoke after another participant (Pj). In step S820, the total number of interactions between participants (TNI) is calculated by summing up all of the times that participant (Pi) spoke after participant (Pj).

Subsequently, in step S825, the average number of interactions (ANT) is calculated by dividing the total number of interactions (TNI) by the number of participants. In step S830, the time elapsed in the meeting so far is measured in seconds, where elapsed time (ET)=current time-meeting start time (MT). Using these metrics, the intensity of group interaction (IPT) is calculated S835 by dividing the average number of interactions (ANT) by the time elapsed (ET) so far. IPT serves as a key performance indicator (KPI) for creative group work, based on empirical scientific research indicating that creativity is enhanced with many short contributions and dense interactions. The KPI is based on empirical evidence, stating that creativity in groups is increased measurably through “many short contributions rather than a few long ones” and “dense interactions: a continuous overlapping cycling between making contributions and very short (less than one second) responsive comments.” The formula used here, group interaction intensity (IPT), measures both factors.

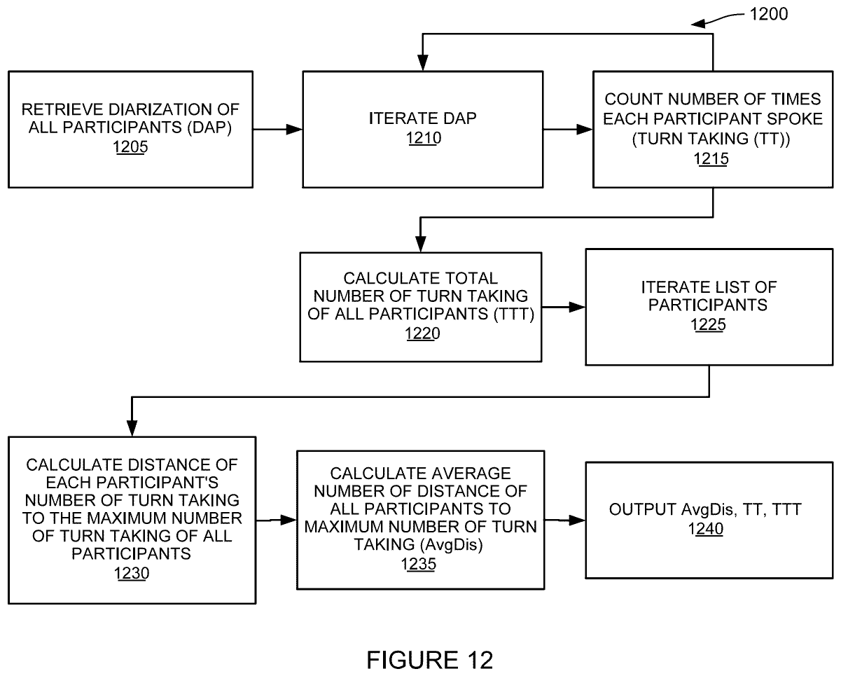

In step S840, the calculated group interaction intensity (IPT) is displayed on a dashboard, such as dashboard 1200 (shown in FIG. 12). The calculated group interaction intensity (IPT) is the main indicator displayed a weather symbol analogy, where higher IPT values correspond to a more favorable assessment 1205 (shown in FIG. 12), akin to sunnier weather. Additionally, the diarization data (DAP), detailing who spoke when and for how long, is employed to generate a bubble chart 1210 (shown in FIG. 12) on the dashboard 1200. This chart 1210 provides insights for the meeting leader or moderator, indicating participants engaged in creativity-stimulating dense interactions versus those potentially monopolizing the discussion with long monologues.

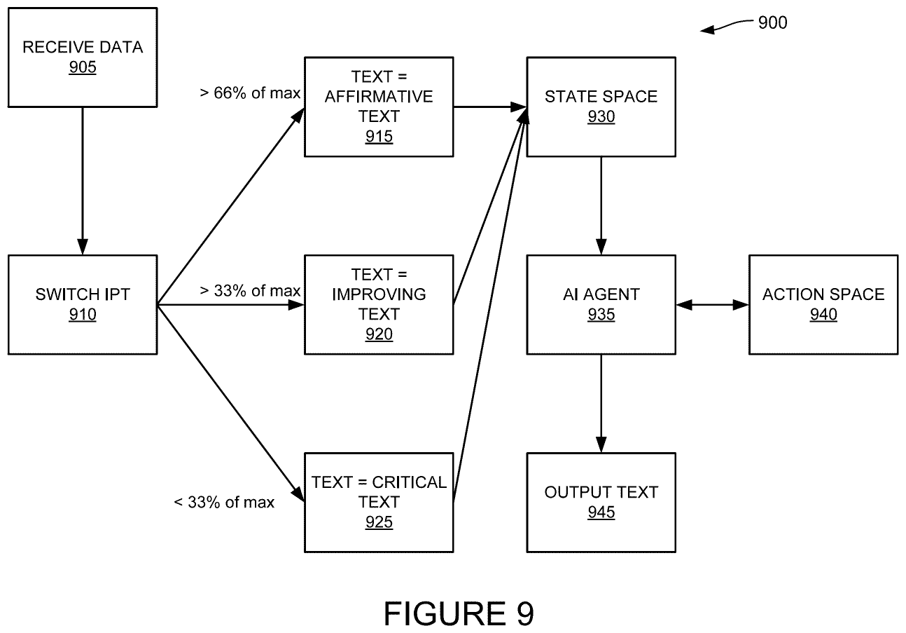

FIG. 9 illustrates a process 900 for enhancing team creativity during online meetings by providing real-time feedback and recommendations to the meeting moderator or leader. Process 900 utilizes a combination of machine learning, natural language processing, and data analytics to assess the dynamics of the meeting and offer actionable insights. The core components include an IPT (Intensity of Group Interaction) monitor, a state space generator, an AI agent, an action space selector, and an output text generator. In the example embodiment, the steps of process 900 are performed by the UI 110, the provider specific backend 115, the host general purpose backend 120 (all shown in FIG. 1), and/or host server 510 (shown in FIG. 5). In the example embodiment, the core components for process 900 including the IPT (Intensity of Group Interaction) monitor, the state space generator, the AI agent, the action space selector, and the output text generator are hosted by one or more of the UI 110, the provider specific backend 115, the host general purpose backend 120, and/or host server 510.

The IPT (Intensity of Group Interaction) monitor continuously measures the level of interaction among participants based on turn-taking and other engagement metrics. The Switch IPT 910 compares the current IPT value against predefined thresholds: if IPT>66% of max, the system 500 (shown in FIG. 5) generates 915 an affirmative text indicating high team creativity; if IPT>33% and ≤ 66% of max, the system 500 generates 920 an improving text suggesting that team creativity is on the rise; and if IPT≤33% of max, the system 500 generates 925 a critical text indicating that team creativity needs improvement. One having skill in the art would understand that these thresholds could be adjusted based on needs and the associated KPIs.

Examples of the different types of text messages are based on the type of feedback and/or meeting scope. For example, real-time feedback would be different than the feedback received for a time series of reoccurring meetings.

Examples of real-time feedback for a productive meeting include, but are not limited to: affirmative feedback: “Your meeting is on track for great productivity;” improving feedback: “Productivity could be improved if Jane Doe and John Doe would give more room to others;” and critical feedback: “John Doe is taking too much time.” Examples of real-time feedback for a creative meeting include, but are not limited to: affirmative feedback: “Your meeting is on track for great creativity!” improving feedback: “Your meeting might will yield greater creativity if you take more turns talking;” and critical feedback: “John Doe is taking too much time and is not leaving enough room for others.” Examples of real-time feedback for a social dynamics meeting include, but are not limited to: affirmative feedback: “You are having a balanced meeting. Great work;” improving feedback: “Jane Doe and John Doe are not participating equally. You might want to involve them more;” and critical feedback: “John Doe is not participating at all. To balance the meeting explicitly give him airtime.”

Examples of feedback for a time series of recurring meetings include, but are not limited to: affirmative feedback: “Your recurring meeting is on track to continuously foster great productivity/creativity;” improving feedback: “Meetings where Jane Doe participated, had an 13% higher productivity rate. Involving her likely yields higher productivity;” and critical feedback: “In most meetings John Doe hardly participates. Try to include all participants. Team Productivity can benefit from this.”

The State Space Generator 930 includes the “Text” generated by the IPT monitor and all relevant metadata from the meeting, such as participant details, speaking patterns, and engagement levels. The AI Agent 935 analyzes the state space and selects the wording with the highest probability of enhancing meeting success. It considers factors like the tone, clarity, and motivational impact of the message. The Action Space Selector 940 holds different text wordings categorized under affirmative, improving, and critical texts. Based on the AI agent's analysis, it selects the most appropriate wording from the action space. The Output Text Generator 945 generates the final text message, chosen from the action space, which is output to the meeting moderator or leader. This message provides feedback or suggestions to improve meeting dynamics and team creativity.

In many embodiments, process 900 occurs after Step 840 (shown in FIG. 8). In the exemplary embodiment, data is received 905. In the example embodiment, the data is the IPT and DAP information from Step 840. The IPT is being monitored in real-time or near real-time.

The current IPT value is compared 910 against predefined thresholds to determine the type of feedback text. These predefined thresholds include a max that is defined in the configuration of the system 500. In some embodiments, the max and thresholds are set by the user. In other embodiments, the max and thresholds are calculated and set by the system 500.

The comparison 910 divides the text up into three categories. If the IPT value>66% of the max, the system 500 generates an affirmative text 915 indicating high team creativity. If the IPT value>33% and ≤66% of the max, the system 500 generates an improving text 1020 suggesting that team creativity is on the rise. And if the IPT value≤33% of the max, the system 500 generates a critical text 1025 indicating that team creativity needs improvement.

The state space generator 930 compiles all relevant meeting data and the generated text. The AI agent 935 selects the most effective wording for the situation. The action space selector 940 chooses the final text from predefined options. The output text 945 is delivered to the meeting moderator or leader.

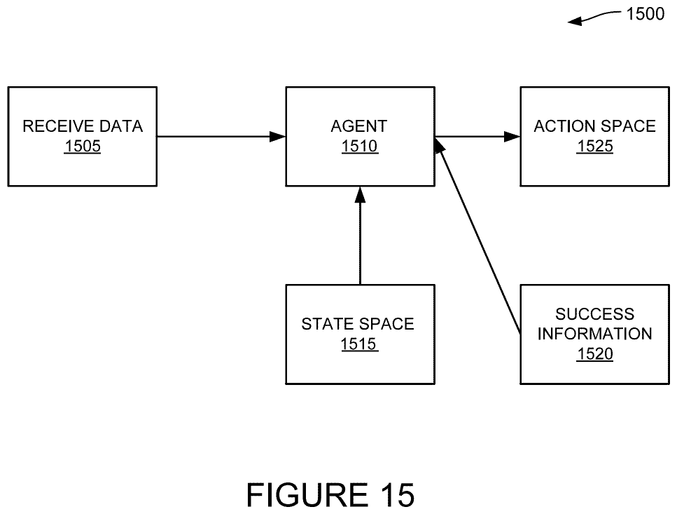

Additionally, the system generates a dashboard 1500 (shown in FIG. 15) to present these key performance indicators (KPIs) and recommendations to users. A dashboard 1500 can be any design or configuration that a user would like to employee in the system. An example of a dashboard 1500, which can be employed, is shown in FIG. 15. The dashboard 1500 utilizes a weather symbol analogy 1505 (shown in FIG. 15), where a sunnier depiction indicates better group creativity. This visual representation provides users with a quick understanding of the overall meeting performance.

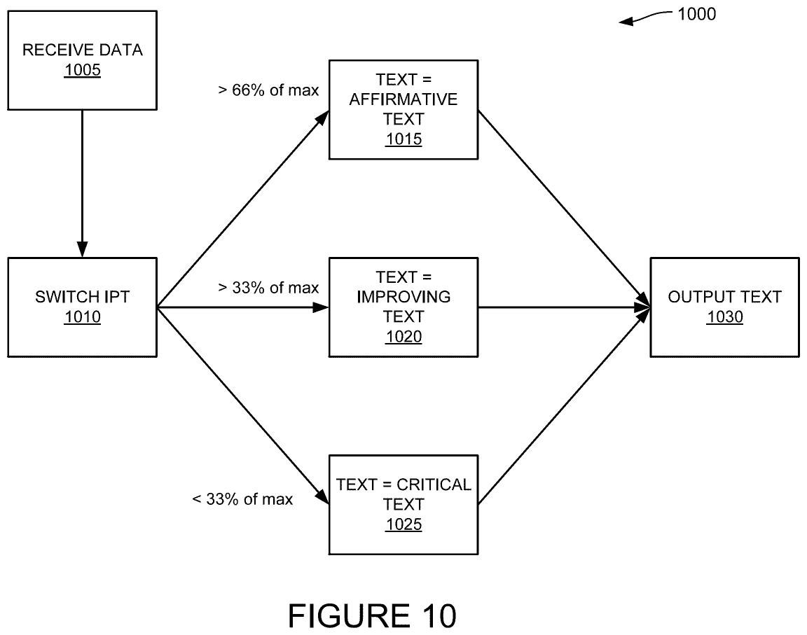

FIG. 10 illustrates a more simplified process 1000 for enhancing team creativity during online meetings, focusing on real-time feedback without the use of AI or reinforcement learning. The process 1000 is designed to monitor and assess the level of interaction among meeting participants and provide categorized feedback to the meeting moderator or leader. The key components include an IPT (Intensity of Group Interaction) monitor and an output text generator 1030.

In the example embodiment, the steps of process 1000 are performed by the UI 110, the provider specific backend 115, the host general purpose backend 120 (all shown in FIG. 1), and/or host server 510 (shown in FIG. 5). In the example embodiment, the core components for process 1000 including the IPT (Intensity of Group Interaction) monitor and the output text generator 1030 are hosted by one or more of the UI 110, the provider specific backend 115, the host general purpose backend 120, and/or host server 510.

The IPT Monitor is responsible for continuously measuring the interaction level among participants. This measurement is based on metrics such as turn-taking frequency, duration, and the overall engagement level during the meeting. The Switch IPT 1010 employs a set of predefined thresholds to categorize the IPT value. The output text generator 1030 takes the categorized feedback from the IPT monitor and produces a final text message. This message is tailored to provide constructive feedback or suggestions to the meeting moderator or leader.

The system 500 provides affirmative feedback, if the IPT is greater than 66% of a maximum predefined value. Furthermore, the system 500 generates affirmative text 1015, indicating that team creativity is high and communication is effective.

The system 500 provides improving feedback, if the IPT is greater than 33% and less than or equal to 66% of the maximum value. Furthermore, the system 500 generates an improving text 1020, suggesting that team creativity is on the rise and that the team is progressing toward more effective communication.

The system 500 provides critical feedback, if the IPT is less than or equal to 33% of the maximum value. The system 500 generates a critical text 1025, indicating that team creativity is low and there is a need for improved communication strategies. One having skill in the art would understand that these thresholds could be adjusted based on needs and the associated KPIs.

Examples of real-time feedback for a productive meeting include, but are not limited to: affirmative feedback: “Your meeting is on track for great productivity;” improving feedback: “Productivity could be improved if Jane Doe and John Doe would give more room to others;” and critical feedback: “John Doe is taking too much time.” Examples of real-time feedback for a creative meeting include, but are not limited to: affirmative feedback: “Your meeting is on track for great creativity!” improving feedback: “Your meeting might will yield greater creativity if you take more turns talking;” and critical feedback: “John Doe is taking too much time and is not leaving enough room for others.” Examples of real-time feedback for a social dynamics meeting include, but are not limited to: affirmative feedback: “You are having a balanced meeting. Great work;” improving feedback: “Jane Doe and John Doe are not participating equally. You might want to involve them more;” and critical feedback: “John Doe is not participating at all. To balance the meeting explicitly give him airtime.”

Examples of feedback for a time series of recurring meetings include, but are not limited to: affirmative feedback: “Your recurring meeting is on track to continuously foster great productivity/creativity;” improving feedback: “Meetings where Jane Doe participated, had an 13% higher productivity rate. Involving her likely yields higher productivity;” and critical feedback: “In most meetings John Doe hardly participates. Try to include all participants. Team Productivity can benefit from this.”

The feedback is designed to be actionable, helping the moderator or leader to make real-time adjustments in the meeting dynamics to foster better communication and enhance team creativity.

In many embodiments, process 1000 occurs after Step 840 (shown in FIG. 8). In the exemplary embodiment, data is received 1005. In the example embodiment, the data is the IPT and DAP information from Step 840. The IPT is being monitored in real-time or near real-time.

The current IPT value is compared 1010 against predefined thresholds to determine the type of feedback text. These predefined thresholds include a max that is defined in the configuration of the system 500. In some embodiments, the max and thresholds are set by the user. In other embodiments, the max and thresholds are calculated and set by the system 500.

The comparison 1010 divides the text up into three categories. If the IPT value>66% of the max, the system 500 generates an affirmative text 1015 indicating high team creativity. If the IPT value>33% and ≤66% of the max, the system 500 generates an improving text 1020 suggesting that team creativity is on the rise. And if the IPT value≤33% of the max, the system 500 generates a critical text 1025 indicating that team creativity needs improvement.

The output text 1030 is delivered to the meeting moderator or leader. Based on the assessment, the output text generator 1030 produces a text message categorized as affirmative, improving, or critical. The final message is delivered to the meeting moderator or leader, providing guidance on how to enhance meeting dynamics and team creativity.

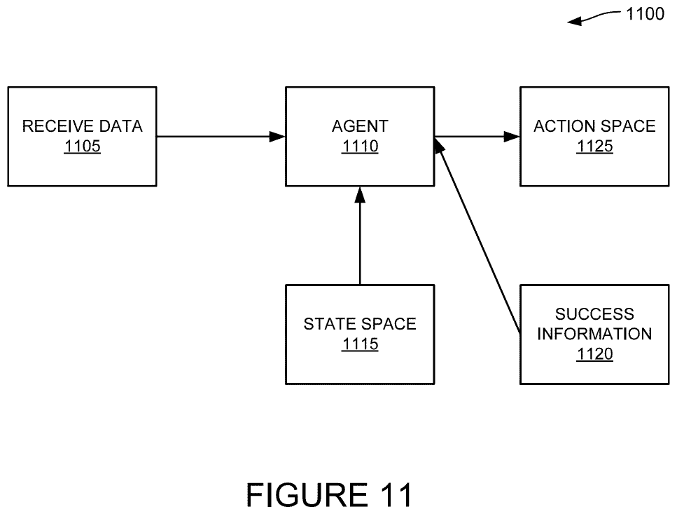

FIG. 11 illustrates deep reinforcement learning process 1100 for this disclosure. In the example embodiment, the steps of process 1100 are performed by the UI 110, the provider specific backend 115, the host general purpose backend 120 (all shown in FIG. 1), and/or host server 510 (shown in FIG. 5).

The process 1100 begins at receiving data, initializing the deep reinforcement learning (DRL) system to evaluate and adapt its recommendation strategies based on meeting success metrics and participant feedback. The process is triggered after a delay of dt seconds following the display of a recommendation to the meeting participants. The parameter dt is defined in the system configuration and determines the interval at which the DRL system reassesses the effectiveness of its recommendations.

The state space 1115 comprises all metadata of the meeting, including participant information, meeting duration, speaking patterns, and any feedback provided by the participants. This state space 1115 is continuously updated with new data as the meeting progresses and recommendations are made.

The AI agent 1110 operates within the DRL framework. It continuously adapts its action space based on the state space 1115 and the success information received 1120. The success information 1120 includes how the meeting KPIs (such as productivity, engagement, and communication effectiveness) have evolved following the recommendation.

The state space 1115 and the AI agent 1110 interact simultaneously, where the AI agent (i) monitors the updated state space to gather contextual information about the meeting dynamics and participant behaviors and (ii) analyzes the success information to evaluate the impact of the previous recommendation.

Based on the analysis of the success information 1120, the AI agent 1110 adapts its action space. The action space 1125 consists of different textual wordings and recommendations categorized as affirmative, improving, or critical. The AI agent 1110 (i) modifies the probability distribution of selecting specific wordings or recommendations and (ii) learns from the outcomes of previous recommendations to optimize future suggestions.

The process concludes with the AI agent 1110 having adapted its action space to improve the likelihood of generating successful recommendations 1120 in future meetings. This adaptive learning process 1100 enhances the overall effectiveness of the recommender system by ensuring that feedback is increasingly tailored to the specific needs and dynamics of each team.

FIG. 12 illustrates an example process 1200 for dynamic diarization-based group performance analysis in online meetings. In the example embodiment, the steps of process 1200 are performed by the UI 110, the provider specific backend 115, the host general purpose backend 120 (all shown in FIG. 1), and/or host server 510 (shown in FIG. 5). The steps of process 1200 occur while processes 100 and/or 200 are occurring (shown in FIGS. 1 and 2, respectively). In many embodiments, process 1200 occurs during step S190 (shown in FIG. 1) and/or step S275 (shown in FIG. 2). Process 1200 enhances the understanding of group dynamics and participant behavior by leveraging diarization data stored in the user datastore 125 (shown in FIG. 1).

In step S1205, diarization data of all meeting participants (DAP) is retrieved at a regular time intervals, such as a default interval of 0.5 seconds. This data may be retrieved S1205 from the host datastore 125 (shown in FIG. 1). In steps S1210 and S1215, the diarization data structure for each participant is traversed by an algorithm that counts each time a participant (Pi) speaks. This count allows for the calculation of the number of times each participant spoke, referred to as participant's turn taking (TT). In step S1220, by summing the turn takings of all participants, the total number of times someone spoke in the meeting (TTT) is computed.

In steps S1225 and S1230, the process 1200 iterates through the list of participants, to calculate the distance of each participant's turn taking (TT) to the maximum number of turn taking of all participants (TTT). Based on this data, the average turn taking (AvgDis) is calculated S1235 based on the average distance of all participants' turn taking from the maximum number of turn taking (TTT). This AvgDis metric serves as an indicator for group intelligence, where lower AvgDis values signify better group performance.

Based on strong empirical evidence, “The largest factor in predicting group intelligence was the equality of conversational turn taking.” This is used as KPI here. However, the operationalization of this factor as reverse variance of turn taking (the lower the variance, the better) found in the study of onsite groups of around 5 people needs to be adapted to fit to online video conferences of various group sizes. Therefore, a different metric to measure “turn taking” was chosen: the reverse average distance to the maximum of turn taking within the group (AvgDis).

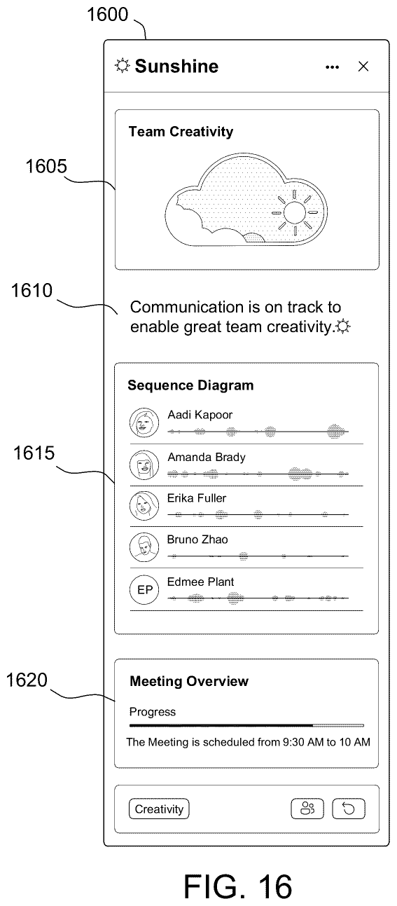

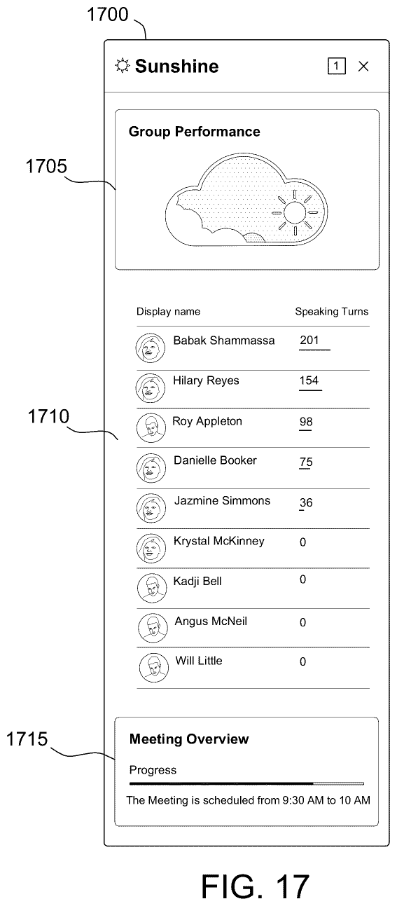

Additionally, the system generates one or more dashboards 1600 and 1700 (shown in FIGS. 16 and 17) to present these key performance indicators (KPIs) to users. The dashboards 1600 or 1700 can be any design or configuration that a user would like to employee in the system. An example of a dashboard 1600 or 1700, which can be employed, is shown in FIGS. 16 and 17. The dashboards 1600 or 1700 utilize a weather symbol analogy 1605 or 1705 (shown in FIG. 17), where a sunnier depiction indicates better group creativity. This visual representation provides users with a quick understanding of the overall meeting performance.

Furthermore, the TT metric is utilized to identify deviations from the average turn taking, allowing the moderator or leader of the meeting to discern which team members may need encouragement to speak more or less to optimize team performance.

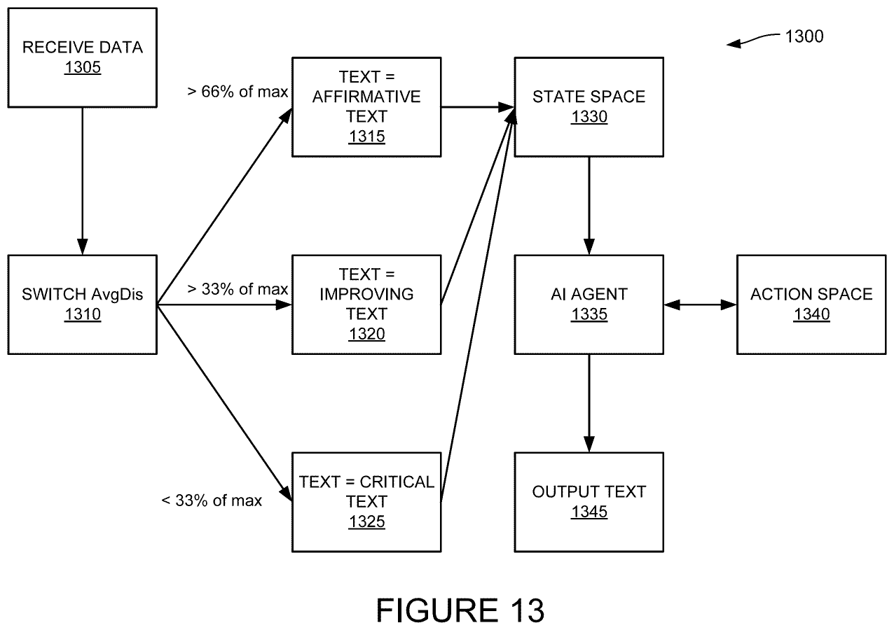

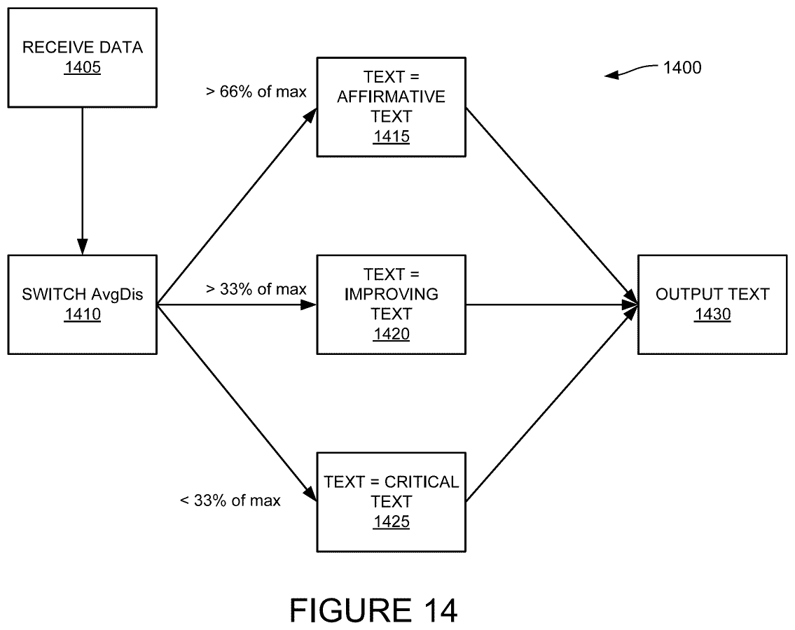

Generally, FIGS. 13 and 14 illustrate a recommender system designed to assist meeting leaders and moderators in enhancing the performance of meetings. In some embodiments, FIGS. 13 and 14 are similar to FIGS. 9 and 10, respectively. Furthermore, FIGS. 13 and 14 may be used with the system shown in FIG. 11. By analyzing key performance indicators (KPIs) related to meeting success, the system generates real-time recommendations to improve productivity, creativity, and time efficiency during meetings.

Generally, a self-learning recommender system that advises meeting leaders and moderators to improve meeting performance by analyzing meeting KPIs and providing actionable recommendations is provided herein. The system evaluates metrics such as meeting productivity, creativity, and time efficiency in real time and suggests behavioral changes to enhance these aspects. Recommendations are delivered in a user-friendly manner and adapted over time based on their effectiveness in specific social contexts through deep reinforcement learning.

The recommender system includes the following components: a KPI Analysis Module, a Metadata Analysis Engine, a Behavioral Change Calculation Module, a Recommendation Generator, and a Self-Learning Algorithm.

The KPI Analysis Module continuously monitors and analyzes various meeting KPIs, including but not limited to productivity, creativity, and time efficiency. The analysis is based on data collected from meeting interactions, participant behavior, and meeting outcomes.

The Metadata Analysis Engine processes the metadata of meetings in real time. This includes information such as meeting duration, participant engagement levels, speech patterns, and interaction frequencies. The engine correlates these metadata with the KPIs to identify areas needing improvement.

The Behavioral Change Calculation Module uses metadata analysis to calculate potential behavioral changes that could lead to higher KPI achievement. The calculations consider various factors, including participant roles, meeting objectives, and historical meeting data.

The Recommendation Generator formulates recommendations for meeting leaders and moderators. The recommendations are crafted in a user-friendly manner, offering multiple options where applicable and using relatable tonality. This approach is based on proven team coaching techniques.

The Self-Learning Algorithm is employed for deep reinforcement learning, to continuously adapt its recommendations. It learns from the effectiveness of past recommendations in specific social contexts, such as particular teams or types of meetings, and adjusts future suggestions accordingly.

FIG. 13 outlines a systematic process 1300 of evaluating team productivity in online meetings and providing tailored recommendations to improve group performance using AI agent-optimized feedback. In the example embodiment, the steps of process 1300 are performed by the UI 110, the provider specific backend 115, the host general purpose backend 120 (all shown in FIG. 1), and/or host server 510 (shown in FIG. 5). In the example embodiment, the core components for process 1200 including the KPI Analysis Module, a Metadata Analysis Engine, a Behavioral Change Calculation Module, a Recommendation Generator, and a Self-Learning Algorithm are hosted by one or more of the UI 110, the provider specific backend 115, the host general purpose backend 120, and/or host server 510.

The process 1300 begins with receiving data 1405 initializing the recommender system to analyze team productivity based on the received data including diarization data and calculated metrics, and to generate tailored recommendations aimed at improving meeting success.

The system retrieves the diarization data 1305 stored in the user datastore at regular intervals. An algorithm traverses the diarization data structure for each participant, counting each time a participant speaks (turn taking, TT). By summing the turn takings of all participants, the total number of times someone spoke in the meeting (total turn taking, TTT) is computed. The system calculates the average distance of all participants' turn taking from the average turn taking (AvgDis). The AvgDis metric serves as an indicator for group intelligence, where lower AvgDis values signify better group performance.

The system uses a decision-making process (Switch AvgDis) 1310 to categorize the calculated AvgDis into three performance categories. This categorization determines the appropriate textual feedback to provide to the meeting participants.

If the AvgDis is greater than 66% of the maximum possible AvgDis, it indicates a high level of group intelligence and effective team performance. The system identifies this scenario as requiring “affirmativeText” feedback 1315, which includes positive messages affirming the team's productivity.

If the AvgDis is greater than 33% but less than or equal to 66% of the maximum possible AvgDis, it indicates a moderate level of group intelligence and team performance. The system identifies this scenario as requiring “improvingText” feedback 1320, which includes constructive messages suggesting areas for improvement.

If the AvgDis is less than or equal to 33% of the maximum possible AvgDis, it indicates a low level of group intelligence and poor team performance. The system identifies this scenario as requiring “criticalText” feedback 1325, which includes critical messages emphasizing the need for significant improvements.

The State Space 1330 comprises the identified textual feedback category (“affirmativeText,” “improvingText,” or “criticalText”) along with all metadata of the meeting, including participant information, meeting duration, and other relevant data.

The AI agent 1335 processes the state space to determine the most effective wording for the feedback. The action space 1340 of the AI agent 1335 contains different text wordings for each feedback category (affirmativeText, improvingText, and criticalText). The AI agent 1335 selects the wording that has the highest probability of improving meeting success based on historical data and learning algorithms.

The system outputs the selected textual feedback to the meeting participants. The feedback is output 1345 in a user-friendly manner, offering multiple options where applicable and using relatable tonality based on proven team coaching techniques. The process provides actionable recommendations to the meeting participants based on their performance metrics and the AI agent's optimized feedback wording.

FIG. 14 outlines a systematic process 1400 of evaluating team productivity in online meetings and providing tailored recommendations to improve group performance. In the example embodiment, the steps of process 1400 are performed by the UI 110, the provider specific backend 115, the host general purpose backend 120 (all shown in FIG. 1), and/or host server 510 (shown in FIG. 5). In the example embodiment, the core components for process 1400 including the KPI Analysis Module, a Metadata Analysis Engine, a Behavioral Change Calculation Module, a Recommendation Generator, and a Self-Learning Algorithm are hosted by one or more of the UI 110, the provider specific backend 115, the host general purpose backend 120, and/or host server 510.

The process 1400 begins with receiving data 1405 to initialize the recommender system to analyze team productivity based on the data including diarization data and calculated metrics. The system aims to provide actionable recommendations for improving meeting performance.

The system retrieves 1405 the diarization data stored in the user datastore at regular intervals, typically parameterized with a default interval of 0.5 seconds. An algorithm traverses the diarization data structure for each participant, counting each time a participant speaks (turn taking, TT). By summing the turn takings of all participants, the total number of times someone spoke in the meeting (total turn taking, TTT) is computed. The system calculates the average distance of all participants' turn taking from the average turn taking (AvgDis). The AvgDis metric serves as an indicator for group intelligence, where lower AvgDis values signify better group performance.

The system uses a decision-making process (Switch AvgDis) 1410 to categorize the calculated AvgDis into three performance categories. This categorization determines the appropriate textual feedback to provide to the meeting participants.

If the AvgDis is greater than 66% of the maximum possible AvgDis, it indicates a high level of group intelligence and effective team performance. The system generates an “affirmativeText” message 1415, which includes positive feedback affirming the team's productivity and encouraging them to maintain their current performance.

If the AvgDis is greater than 33% but less than or equal to 66% of the maximum possible AvgDis, it indicates a moderate level of group intelligence and team performance. The system generates an “improvingText” message 1420, which includes constructive feedback highlighting areas of improvement and suggesting ways to enhance team productivity.

If the AvgDis is less than or equal to 33% of the maximum possible AvgDis, it indicates a low level of group intelligence and poor team performance. The system generates a “criticalText” message 1425, which includes critical feedback emphasizing the need for significant improvements and offering specific recommendations to address performance issues.

Based on the determined performance category (affirmativeText, improvingText, or criticalText), the system outputs 1430 the corresponding textual feedback. This feedback is delivered in a user-friendly manner, offering multiple options where applicable and using relatable tonality based on proven team coaching techniques. The system aims to continuously improve meeting productivity by offering targeted feedback and encouraging positive behavioral changes.

The process begins at the “START” node, initializing the recommender system to analyze team productivity based on diarization data and calculated metrics, and to generate tailored recommendations aimed at improving meeting success.

The system retrieves the diarization data stored in the user datastore at regular intervals. An algorithm traverses the diarization data structure for each participant, counting each time a participant speaks (turn taking, TT). By summing the turn takings of all participants, the total number of times someone spoke in the meeting (total turn taking, TTT) is computed. The system calculates the average distance of all participants' turn taking from the average turn taking (AvgDis). The AvgDis metric serves as an indicator for group intelligence, where lower AvgDis values signify better group performance.

The system uses a decision-making process (Switch AvgDis) to categorize the calculated AvgDis into three performance categories. This categorization determines the appropriate textual feedback to provide to the meeting participants.

If the AvgDis is greater than 66% of the maximum possible AvgDis, it indicates a high level of group intelligence and effective team performance. The system identifies this scenario as requiring “affirmativeText” feedback, which includes positive messages affirming the team's productivity.

If the AvgDis is greater than 33% but less than or equal to 66% of the maximum possible AvgDis, it indicates a moderate level of group intelligence and team performance. The system identifies this scenario as requiring “improvingText” feedback, which includes constructive messages suggesting areas for improvement.

If the AvgDis is less than or equal to 33% of the maximum possible AvgDis, it indicates a low level of group intelligence and poor team performance. The system identifies this scenario as requiring “criticalText” feedback, which includes critical messages emphasizing the need for significant improvements.

The State Space comprises the identified textual feedback category (“affirmativeText,” “improvingText,” or “criticalText”) along with all metadata of the meeting, including participant information, meeting duration, and other relevant data.

The AI agent processes the state space to determine the most effective wording for the feedback. The action space of the AI agent contains different text wordings for each feedback category (affirmativeText, improvingText, and criticalText). The AI agent selects the wording that has the highest probability of improving meeting success based on historical data and learning algorithms.

The system outputs the selected textual feedback to the meeting participants. The feedback is delivered in a user-friendly manner, offering multiple options where applicable and using relatable tonality based on proven team coaching techniques.

The process concludes at the “END” node, having provided actionable recommendations to the meeting participants based on their performance metrics and the AI agent's optimized feedback wording.

FIG. 15 illustrates deep reinforcement learning process 1500 for this disclosure. In the example embodiment, the steps of process 1500 are performed by the UI 110, the provider specific backend 115, the host general purpose backend 120 (all shown in FIG. 1), and/or host server 510 (shown in FIG. 5).

The process 1500 begins at receiving data, initializing the deep reinforcement learning (DRL) system to evaluate and adapt its recommendation strategies based on meeting success metrics and participant feedback. The process is triggered after a delay of dt seconds following the display of a recommendation to the meeting participants. The parameter dt is defined in the system configuration and determines the interval at which the DRL system reassesses the effectiveness of its recommendations.

The state space 1515 comprises all metadata of the meeting, including participant information, meeting duration, speaking patterns, and any feedback provided by the participants. This state space 1515 is continuously updated with new data as the meeting progresses and recommendations are made.

The AI agent 1510 operates within the DRL framework. It continuously adapts its action space based on the state space 1515 and the success information received 1520. The success information 1520 includes how the meeting KPIs (such as productivity, engagement, and communication effectiveness) have evolved following the recommendation.

The state space 1515 and the AI agent 1510 interact simultaneously, where the AI agent (i) monitors the updated state space to gather contextual information about the meeting dynamics and participant behaviors and (ii) analyzes the success information to evaluate the impact of the previous recommendation.

Based on the analysis of the success information 1520, the AI agent 1510 adapts its action space. The action space 1525 consists of different textual wordings and recommendations categorized as affirmative, improving, or critical. The AI agent 1510 (i) modifies the probability distribution of selecting specific wordings or recommendations and (ii) learns from the outcomes of previous recommendations to optimize future suggestions.

The process concludes with the AI agent 1510 having adapted its action space to improve the likelihood of generating successful recommendations 1520 in future meetings. This adaptive learning process 1500 enhances the overall effectiveness of the recommender system by ensuring that feedback is increasingly tailored to the specific needs and dynamics of each team.

FIG. 16 illustrates an example dashboard 1600 for use with processes 800, 900, 1000, and 1100 (shown in FIGS. 8-11). Dashboard 1600 depicts an example of a group performance indicator 1605, a Group Performance Weather Indicator, a visual representation of reverse average distance to the maximum of turn taking (AvgDis). The lower the AvgDis, the better. The dashboard 1600 utilizes a weather symbol analogy, where a sunnier depiction indicates better group intelligence. This visual representation 1605 provides users with a quick understanding of the overall meeting performance. This is abstracted to four weather scenarios (sunny, partly cloudy, cloudy, and rainy).

A recommendation 1610 advises one or more users how they or others could increase team creativity as moderator or leader of the meeting. The recommendation 1610 provides several concrete options. It also affirms if communication is back on track for high team creativity.

A middle indicator 1615 display illustrates each user's speaking times relative to the meeting's timeline, with larger bubbles representing longer durations of speech based on the diarization of all participants (DAP). A bottom indicator 1620 displays meeting progress as the current status of the meeting in relation to its scheduled duration.

Furthermore, the TT metric is utilized to identify deviations from the average turn taking, allowing the moderator or leader of the meeting to discern which team members may need encouragement to speak more or less to optimize team performance.

FIG. 17 illustrates an example dashboard 1700 for use with process processes 1200, 1300, 1400, and 1500 (shown in FIGS. 12-15). Dashboard 1700 is designed to provide comprehensive insights into group dynamics and meeting progress, facilitating efficient management and assessment of collaborative sessions. The dashboard 1700 integrates various visual elements and metrics to offer a holistic view of participant involvement, meeting progression, and group intelligence indicators.

The primary feature of the dashboard is the graphical representation of group dynamics, which includes multiple components:

Dashboard 1700 depicts an example of a group performance indicator 1705, a Group Performance Weather Indicator, a visual representation of reverse average distance to the maximum of turn taking (AvgDis). The lower the AvgDis, the better. The dashboard 1700 utilizes a weather symbol analogy, where a sunnier depiction indicates better group intelligence. This visual representation 1705 provides users with a quick understanding of the overall meeting performance. This is abstracted to four weather scenarios (sunny, partly cloudy, cloudy, and rainy).

Participant Involvement 1710 utilizes the TT attribute and lists the participants by the number of turns that each has taken. This representation 1710 categorizes participant involvement as balanced, mixed, or unbalanced, providing a quick assessment of the distribution of speaking opportunities among meeting attendees. This feature aids in identifying potential imbalances in participation and encourages equitable engagement. The Participant Involvement 1710 showcases the distribution of turns among meeting participants, offering insights into individual contributions and overall participation dynamics. By highlighting disparities or dominance in speaking turns, this feature contributes to the assessment of group intelligence and facilitates interventions to promote inclusive discussions. A bottom indicator 1715 displays meeting progress as the current status of the meeting in relation to its scheduled duration.

Overall, the dashboard 1700 serves as a comprehensive tool for monitoring and optimizing group dynamics, fostering effective collaboration, and maximizing meeting outcomes.

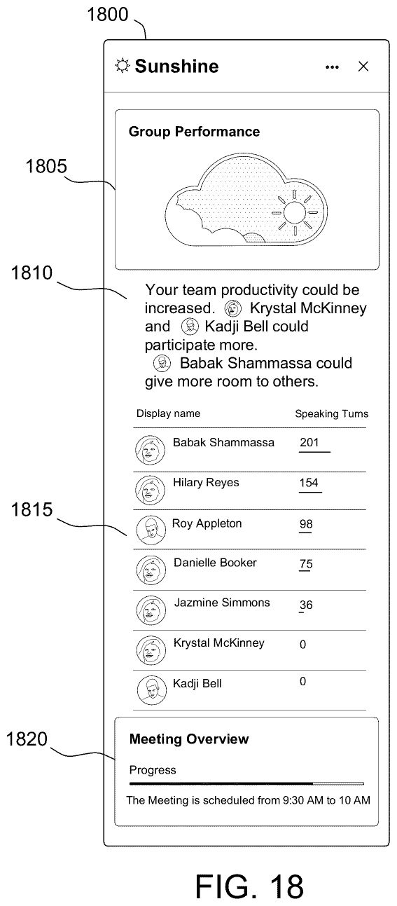

FIG. 18 illustrates an example dashboard 1800 for use with process processes 1200, 1300, 1400, and 1500 (shown in FIGS. 12-15). Dashboard 1800 a screenshot of a Recommender System designed to enhance team productivity by providing actionable recommendations to meeting moderators or leaders. The system leverages accumulated meeting data and analysis to offer specific guidance aimed at improving meeting outcomes.

The dashboard 1800 showcases the user interface of the Recommender System, designed to be intuitive and user-friendly for meeting moderators or leaders. It presents several concrete options for enhancing team performance during meetings.

Dashboard 1800 depicts an example of a group performance indicator 1805, a Group Performance Weather Indicator, a visual representation of reverse average distance to the maximum of turn taking (AvgDis). The lower the AvgDis, the better. The dashboard 1800 utilizes a weather symbol analogy, where a sunnier depiction indicates better group intelligence. This visual representation 1805 provides users with a quick understanding of the overall meeting performance. This is abstracted to four weather scenarios (sunny, partly cloudy, cloudy, and rainy).

The UI displays multiple recommendation options 1810 tailored to the current meeting context. These options 1810 are derived from real-time analysis of meeting data, including participant engagement, communication effectiveness, and meeting KPIs.

Each recommendation option 1810 provides actionable guidance aimed at addressing specific challenges or enhancing specific aspects of meeting dynamics. The guidance is based on proven strategies and best practices in team collaboration and meeting facilitation.

The Recommender System offers real-time feedback based on ongoing meeting data. It continuously updates its recommendations as the meeting progresses, ensuring relevance and effectiveness.

The moderator or leader can interact with the UI to review the recommendations and select the most appropriate actions based on their assessment of the meeting dynamics and goals.

Participant Involvement 1815 utilizes the TT attribute and lists the participants by the number of turns that each has taken. This representation 1815 categorizes participant involvement as balanced, mixed, or unbalanced, providing a quick assessment of the distribution of speaking opportunities among meeting attendees. This feature aids in identifying potential imbalances in participation and encourages equitable engagement. The Participant Involvement 1815 showcases the distribution of turns among meeting participants, offering insights into individual contributions and overall participation dynamics. By highlighting disparities or dominance in speaking turns, this feature contributes to the assessment of group intelligence and facilitates interventions to promote inclusive discussions.

A Meeting Progress Indicator 1820 visualizes the ratio of elapsed time to scheduled time, expressed as a percentage. This provides a real-time view of how much of the meeting time has been used relative to the total scheduled duration.

The primary goal of the Recommender System is to empower moderators and leaders with tools to enhance team performance. By providing tailored recommendations, it aims to improve productivity, creativity, and overall meeting effectiveness.

### Additional Considerations

Example embodiments of compressor systems and methods, such as refrigerant compressors, are described above in detail. The systems and methods are not limited to the specific embodiments described herein, but rather, components of the system and methods may be used independently and separately from other components described herein. For example, the cooling circuits described herein may be used in compressors other than centrifugal compressors, including, for example and without limitation, scroll compressors, rotary compressors, and reciprocating compressors.

As will be appreciated based upon the foregoing specification, the above-described embodiments of the disclosure may be implemented using computer programming or engineering techniques including computer software, firmware, hardware or any combination or subset thereof. Any such resulting program, having computer-readable code means, may be embodied or provided within one or more computer-readable media, thereby making a computer program product, i.e., an article of manufacture, according to the discussed embodiments of the disclosure. The computer-readable media may be, for example, but is not limited to, a fixed (hard) drive, diskette, optical disk, magnetic tape, semiconductor memory such as read-only memory (ROM), and/or any transmitting/receiving medium, such as the Internet or other communication network or link. The article of manufacture containing the computer code may be made and/or used by executing the code directly from one medium, by copying the code from one medium to another medium, or by transmitting the code over a network.

These computer programs (also known as programs, software, software applications, “apps,” or code) include machine instructions for a programmable processor, and can be implemented in a high-level procedural and/or object-oriented programming language, and/or in assembly/machine language. As used herein, the terms “machine-readable medium” and “computer-readable medium” refer to any computer program product, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The “machine-readable medium” and “computer-readable medium,” however, do not include transitory signals. The term “machine-readable signal” refers to any signal used to provide machine instructions and/or data to a programmable processor.

As used herein, a processor may include any programmable system including systems using micro-controllers, reduced instruction set circuits (RISC), application specific integrated circuits (ASICs), logic circuits, and any other circuit or processor capable of executing the functions described herein. The above examples are example only and are thus not intended to limit in any way the definition and/or meaning of the term “processor.”

As used herein, the terms “software” and “firmware” are interchangeable, and include any computer program stored in memory for execution by a processor, including RAM memory, ROM memory, EPROM memory, EEPROM memory, and non-volatile RAM (NVRAM) memory. The above memory types are example only, and are thus not limiting as to the types of memory usable for storage of a computer program.

As used herein, the term “database” can refer to either a body of data, a relational database management system (RDBMS), or to both. As used herein, a database can include any collection of data including hierarchical databases, relational databases, flat file databases, object-relational databases, object-oriented databases, and any other structured collection of records or data that is stored in a computer system. The above examples are example only, and thus are not intended to limit in any way the definition and/or meaning of the term database. Examples of RDBMS' include, but are not limited to including, Oracle® Database, MySQL, IBM® DB2, Microsoft® SQL Server, Sybase®, and PostgreSQL. However, any database can be used that enables the systems and methods described herein. (Oracle is a registered trademark of Oracle Corporation, Redwood Shores, California; IBM is a registered trademark of International Business Machines Corporation, Armonk, New York; Microsoft is a registered trademark of Microsoft Corporation, Redmond, Washington; and Sybase is a registered trademark of Sybase, Dublin, California.)

In another example, a computer program is embodied on a computer-readable medium. In an example, the system is executed on a single computer system, without requiring a connection to a server computer. In a further example, the system is being run in a Windows® environment (Windows is a registered trademark of Microsoft Corporation, Redmond, Washington). In yet another example, the system is run on a mainframe environment and a UNIX® server environment (UNIX is a registered trademark of X/Open Company Limited located in Reading, Berkshire, United Kingdom). In a further example, the system is run on an iOS® environment (iOS is a registered trademark of Cisco Systems, Inc. located in San Jose, CA). In yet a further example, the system is run on a Mac OS® environment (Mac OS is a registered trademark of Apple Inc. located in Cupertino, CA). In still yet a further example, the system is run on Android® OS (Android is a registered trademark of Google, Inc. of Mountain View, CA). In another example, the system is run on Linux® OS (Linux is a registered trademark of Linus Torvalds of Boston, MA). The application is flexible and designed to run in various different environments without compromising any major functionality.

As used herein, an element or step recited in the singular and proceeded with the word “a” or “an” should be understood as not excluding plural elements or steps, unless such exclusion is explicitly recited. Furthermore, references to “example” or “one example” of the present disclosure are not intended to be interpreted as excluding the existence of additional examples that also incorporate the recited features. Further, to the extent that terms “includes,” “including,” “has,” “contains,” and variants thereof are used herein, such terms are intended to be inclusive in a manner similar to the term “comprises” as an open transition word without precluding any additional or other elements.

As used herein, the terms “software” and “firmware” are interchangeable and include any computer program stored in memory for execution by a processor, including RAM memory, ROM memory, EPROM memory, EEPROM memory, and non-volatile RAM (NVRAM) memory. The above memory types are example only, and are thus not limiting as to the types of memory usable for storage of a computer program.

Furthermore, as used herein, the term “real-time” refers to at least one of the time of occurrence of the associated events, the time of measurement and collection of predetermined data, the time to process the data, and the time of a system response to the events and the environment. In the examples described herein, these activities and events occur substantially instantaneously.

In some embodiments, the system includes multiple components distributed among a plurality of computer devices. One or more components may be in the form of computer-executable instructions embodied in a computer-readable medium. The systems and processes are not limited to the specific embodiments described herein. In addition, components of each system and each process can be practiced independent and separate from other components and processes described herein. Each component and process can also be used in combination with other assembly packages and processes. The present embodiments may enhance the functionality and functioning of computers and/or computer systems.

The computer-implemented methods discussed herein can include additional, less, or alternate actions, including those discussed elsewhere herein. The methods can be implemented via one or more local or remote processors, transceivers, servers, and/or sensors (such as processors, transceivers, servers, and/or sensors mounted on vehicles or mobile devices, or associated with smart infrastructure or remote servers), and/or via computer-executable instructions stored on non-transitory computer-readable media or medium. Additionally, the computer systems discussed herein can include additional, less, or alternate functionality, including that discussed elsewhere herein. The computer systems discussed herein can include or be implemented via computer-executable instructions stored on non-transitory computer-readable media or medium.

As used herein, the term “non-transitory computer-readable media” is intended to be representative of any tangible computer-based device implemented in any method or technology for short-term and long-term storage of information, such as, computer-readable instructions, data structures, program modules and sub-modules, or other data in any device. Therefore, the methods described herein can be encoded as executable instructions embodied in a tangible, non-transitory, computer readable medium, including, without limitation, a storage device and/or a memory device. Such instructions, when executed by a processor, cause the processor to perform at least a portion of the methods described herein. Moreover, as used herein, the term “non-transitory computer-readable media” includes all tangible, computer-readable media, including, without limitation, non-transitory computer storage devices, including, without limitation, volatile and nonvolatile media, and removable and non-removable media such as a firmware, physical and virtual storage, CD-ROMs, DVDs, and any other digital source such as a network or the Internet, as well as yet to be developed digital means, with the sole exception being a transitory, propagating signal.

The patent claims at the end of this document are not intended to be construed under 35 U.S.C. § 112 (f) unless traditional means-plus-function language is expressly recited, such as “means for” or “step for” language being expressly recited in the claim(s).

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

What is claimed is:

1. A system for dynamically generating and analyzing metadata for online meetings, the system comprising a computer device comprising at least one processor in communication with at least one memory device, wherein the at least one memory device stores computer-implemented instructions that cause the at least one processor to:
receive at least one stream of at least one of audio and video of an online meeting, wherein the at least one stream includes a plurality of participants participating in the online meeting;
extract a plurality of metadata from the at least one stream;
perform diarization on the at least one stream and the plurality of metadata the at least one stream to generate diarization information, wherein the diarization information includes information about participation for the plurality of participants in the online meeting;
analyze the diarization information to calculate one or more key performance indicators (KPIs);
determine a recommendation to change the one or more KPIs; and
generate visualization of at least one of the key performance indicators and the recommendation to be displayed to one or more participants in the online meeting.

2. The system of claim 1, wherein the online meeting is occurring in real-time.

3. The system of claim 1, wherein the one or more key performance indicators include a group interaction intensity based on an average number of interactions for the plurality of participants in the online meeting.

4. The system of claim 1, wherein the one or more key performance indicators include a number of times that each participant spoke, a total number of turns taken by all participants, and an average distance of each participant from the maximum number of turn taking performed by a participant.

5. The system of claim 1, wherein the at least one processor is further programmed to generate a user interface to display a visual representation of one or more of the KPIs as a weather symbol analogy.

6. The system of claim 1, wherein the one or more key performance indicators include at least one of a group interaction intensity based on an average number of interactions for the plurality of participants in the online meeting, a number of times that each participant spoke, a total number of turns taken by all participants, and an average distance of each participant from the maximum number of turn taking performed by a participant.

7. The system of claim 1, wherein the at least one processor is further programmed to determine a recommendation to change the one or more KPIs by executing a model trained using artificial intelligence.

8. The system of claim 1, wherein the model is trained using historical success information.

9. The system of claim 7, wherein the at least one processor is further programmed to determine a strength of the recommendation based on at least one of the KPIs.

10. The system of claim 9, wherein the at least one processor is further programmed to generate text for the recommendation based on the determined strength of the recommendation.

11. The system of claim 9, wherein the strength of the recommendation is determined by comparing the at least one of the KPIs to a predetermined threshold.

12. The system of claim 11, wherein the at least one processor is further programmed to generate affirmative text if the at least one of the KPIs is greater than a first percentage of the predetermined threshold.

13. The system of claim 12, wherein the at least one processor is further programmed to generate improving text if the at least one of the KPIs is between a first percentage and a second percentage of the predetermined threshold.

14. The system of claim 13, wherein the at least one processor is further programmed to generate critical text if the at least one of the KPIs is less than a second percentage of the predetermined threshold.

15. The system of claim 1, wherein the key performance indicators are calculated subsequent to completion of the online meeting and transmitted to one or more participants of the online meeting.

16. The system of claim 1, further comprising:
a meeting metadata capture module configured to collect data generated during online meetings, including participant speaking patterns and audio characteristics;
a data processing and analysis module configured to process captured metadata using machine learning algorithms and statistical techniques to extract insights regarding participant behavior and group dynamics and generate meeting success indicators;
a reporting and visualization module configured to generate reports and visualizations summarizing findings from data analysis; and
a recommendation module configured to provide recommendations to increase overall success of the online meeting based on scientific findings at least one of in real time during the online meeting and after the online meeting as a summary report.

17. The system of claim 16, wherein the meeting metadata capture module further captures metadata related to participant location and date/time of participation.

18. The system of claim 16, wherein the data processing and analysis module employs diarization techniques to segment at least one stream of audio data.

19. The system of claim 16, wherein the reporting and visualization module generates visualizations such as graphs and charts to present the analyzed data in an easily interpretable format.

20. The system of claim 16, wherein the reporting and visualization module furnishes meeting participants and third-parties with real-time guidance or analysis after the online meeting, aiding in enhancing meeting success rates.
